(19) United States
(12) Patent Application Publication
(10) Pub. No.: US 2002/0152001 A1
(43) Pub. Date: Oct. 17, 2002

(54) On-demand fulfillment system for the production of customized products

(75) Inventors: Randall S. Knipp, Kansas City, MO (US); Richard R. Gordon, Overland Parks, KS (US); Wesley D. Lindquist, Kansas City, MO (US)

Correspondence Address: PATTON BOGGS, PO BOX 270930, LOUISVILLE, CO, 80027, US

(73) Assignee: Hallmark Cards Incorporated

(21) Appl. No.: 10/092,288

(22) Filed: Mar. 6, 2002

Related U.S. Application Data
(63) Continuation-in-part of application No. 09/951,145, filed on Sep. 13, 2001.
(63) Continuation-in-part of application No. 09/775,311, filed on Feb. 1, 2001.
(63) Continuation-in-part of application No. 09/775,539, filed on Feb. 1, 2001.
(63) Continuation-in-part of application No. 09/775,538, filed on Feb. 1, 2001.
(63) Continuation-in-part of application No. 09/951,144, filed on Sep. 13, 2001.
(63) Continuation-in-part of application No. 09/834,466, filed on Apr. 13, 2001.

(51) Int. Cl. G06F 19/00

(52) U.S. Cl. 700/100; 700/95

(57) ABSTRACT

The on-demand fulfillment system enables customers to customize mass produced social expression products, using sophisticated manufacturing processes, such as the application of foil, emboss, customized writing, customer photographs and the like, which manufacturing processes are integrated on to high quality heavy print stock under tight quality control to produce different effects on the finished product. This is accomplished the use of an automated assembly line that draws production stock from a plurality of sources and can route the production stock through various customer selected manufacturing processes to produce a high quality, yet customized product at a reasonable cost to the customer.

### CROSS-REFERENCE TO RELATED APPLICATIONS

This application is a continuation-in-part of the following U.S. patent applications: Ser. No. 09/951,145, filed Sep. 13, 2001, titled “Integrated Emboss Module”, Ser. No. 09/775,311, filed Feb. 1, 2001, titled “Material Handler Apparatus”, Ser. No. 09/775,539, filed Feb. 1, 2001, titled “Adjustable Folding Table for Cards”, Ser. No. 09/775,538, filed Feb. 1, 2001, titled “Method of and System for Packing Articles”, Ser. No. 09/951,144, filed Sep. 13, 2001, titled “Die Changer with Cone Hole Registration System”, Ser. No. 09/834,466, filed Apr. 13, 2001, titled “Drag-And-Drop Web Site Navigation System”.

### FIELD OF THE INVENTION

This invention relates to the field of custom production of products for a consumer and, in particular, the production of social expression products for a customer on-demand and pursuant to customer selected options.

### PROBLEM

It is a problem in the field of manufacturing systems to automate the production of a product when there are a number of different production processes available to manufacture the product and the customer can select various combinations of these processes. One example of such a product that warrants customer definition and selection is social expression cards. Both the customers and the recipients of the social expression cards have individual tastes that may not match the standard designs of mass produced social expression cards. Present systems that enable customization of social expression cards provide minimal customization of the textual messages contained therein but fail to address the more sophisticated design aspects of the social expression cards.

The present state of the social expression card industry is that there are a number of types of social expression cards that are available for customer selection: e-cards, print at home paper cards, remotely printed paper cards, and standard design cards available in a retail environment.

Of these types of social expression cards, the e-cards have traditionally been provided free of charge to the customer. The selection of e-cards that is available from an e-card vendor's WEB site is typically limited and the customer is provided with a certain minimum amount of customization. The e-cards are useful only if both the customer and the recipient are connected to the Internet and are e-mail customers. In addition, the e-cards provided by e-card vendors typically are simple graphic images for display on the screen of the recipient's personal computer and are largely inappropriate for important or serious occasions.

The print at home paper social expression cards are, like e-cards, limited in the available selection and lack sophistication and product quality due to the limitations inherent in the typical printer. The customer must also have a personal computer, high quality color printer, and access to the Internet. The print at home paper social expression cards are based on designs retrieved via the Internet from a vendor's WEB site or downloaded from a data storage media, such as CD-ROM. In addition, these print at home paper social expression cards cannot utilize high quality, heavy stock paper or any of the sophisticated manufacturing processes, such as the application of foil, emboss, die cut, folding, customized writing, customer photographs, insert addition, envelope addressing and stuffing, and the like, that are the hallmark of professional quality social expression cards. Thus, the print at home cards serve a limited segment of the market and lack any significant customization capability.

The remotely printed paper social expression cards represent a higher quality social expression card than the print at home paper cards, where the customer is provided with the capability to customize the textual message included in the social expression card and optionally provide a photograph for printing therewith. The customer must also have a personal computer and access to the Internet. The customer selects a social expression card from a limited selection provided to the customer via the Internet from the vendor's WEB site. The remotely printed, paper social expression cards are of limited variety due to the limitations imposed by printing the customer's textual message as the last step of the manufacturing process. Thus, the sophisticated manufacturing processes, such as the application of foil, emboss, customized writing, and the like, that are the hallmark of professional quality social expression cards are unavailable to the customer in selecting the remotely printed paper social expression cards.

Finally, the mass produced social expression cards provide the greatest variety, highest quality and sophistication products in the social expression card market. The mass produced social expression cards are designed by highly skilled professionals and integrate various manufacturing processes to produce the premier product in the social expression card market. These mass produced social expression cards are manufactured using a number of different processes, such as the application of foil, emboss, customized writing, customer photographs and the like, which are integrated on to high quality heavy print stock under tight quality control to produce a number of different effects on the finished product. These social expression cards are mass produced using sophisticated manufacturing equipment to achieve the desired quality of product and are cost effective in spite of the sophisticated finishing applied thereto due to the large production runs that are used to manufacture these cards. However, in order to achieve the cost effectiveness and high quality, these social expression cards are immutable, since they are primarily distributed to a mass market via retail outlets. The customer has the capability to include a personal handwritten message to supplement the standard message contained therein and insert photographs or other materials, but the social expression card is fixed in all of its design attributes.

Thus, social expression card customers are provided with two choices: customize the lower quality cards to produce a product that somewhat reflects the customer's personal tastes, which is a very time consuming process, or select a standard mass produced social expression card that most closely matches the customer's personal tastes. There presently is no system available that enables the customer to alter the basic manufacturing process or to customize the social expression cards that are mass produced using sophisticated manufacturing processes, such as the application of foil, emboss, customized writing, customer photographs and the like, which processes are integrated on to high quality heavy print stock under tight quality control to produce a number of different effects on the finished product.

### SOLUTION

The above-described problems are solved and a technical advance achieved by the present on-demand fulfillment system for the production of customized products that enables customers to define a customer-specific product for production. The on-demand fulfillment system translates the customer's product definition into a set of data to define the operation of a series of manufacturing modules, that are operable to perform the product processing tasks on the raw materials that are input to the on-demand fulfillment system. The sequencing of these product processing tasks and the particular tasks that are activated are a function of the customer's product definition and result in the automated production of the desired customer-specific product. The extent of the customization and the nature of the processes that are enabled are a function of the product produced.

As an example of the on-demand fulfillment system, a social expression product manufacturing facility is described. This on-demand fulfillment system enables the customer to customize mass produced social expression products or produce individual customized social expression products, using sophisticated manufacturing processes, such as the application of foil, emboss, customized writing, customer photographs and the like. These processes are executed in a fulfillment center and integrated on to a selected product medium, such as high quality, heavy print stock, under tight quality control to produce different effects on the finished product. The on-demand fulfillment system provides an automated assembly line that draws production stock of the selected product medium from a plurality of sources and can route the production stock through various customer selected manufacturing processes to produce a high quality, yet customized social expression product at a reasonable cost to the customer. The automated assembly line dynamically concatenates various production apparatus into a cooperatively operative system by using a product transportation system that serves to interconnect the various production apparatus.

The on-demand fulfillment system includes a user interface that enables the customer to execute the order entry function. The user interface can serve various selected communication devices and communication media, such as a customer terminal/Electronic Document Interchange (EDI) via an IP network, wireless device via a wireless network, facsimile/telephone via the telephone network, and the like. The social expression product definition and order entry data can be parsed by the on-demand fulfillment system into a plurality of files, each directed to a one of the plurality of manufacturing modules that comprises the manufacturing portion of the on-demand fulfillment system. In this manner, the files can be exported to the plurality of manufacturing modules in a manner that is temporally coordinated with the progression of the partially manufactured social expression product through the automated assembly line.

The electronic definition of the customized social expression product, such as a social expression card, is used to coordinate the manufacturing processes as the raw materials are sequenced through the on-demand fulfillment system. The on-demand fulfillment system can be used to produce customized gift-wrap, tissue, napkins, paper plates, and any other printed material and is not limited to just ink on paper, but can encompass other media and processes. Depending on the product being customized, processes like foil, flitter, flock, bronze, silk-screen, tip-ons can be interposed in the automated assembly line. The automated assembly line is devoid of make ready and is digitally controlled to maintain tight process control and to accommodate specialized production requests. The products produced can be individual products, runs of multiple copies of a product, mixes of these, runs of different classes of products interspersed products at the packaging station. Thus, a customer order can encompass multiple products to produce a coordinated set of social expression and/or entertainment materials, all collectively termed “social expression products” herein.

### BRIEF DESCRIPTION OF THE DRAWING

FIGS. 1A & 1B illustrate the present on-demand fulfillment system for the production of customized products and a typical environment in which it is operational;

FIGS. 2A & 2B illustrates additional details of the present on-demand fulfillment system for the production of customized products;

FIGS. 3A-3D illustrate in flow diagram form the operation of the on-demand fulfillment system to provide the initial customer login as well as the product order and customization processes for the customer;

FIGS. 4A-4B illustrate a typical embodiment of a plurality of product selection pages that are displayed to a customer;

FIGS. 5A-5H illustrate a typical embodiment of a plurality of product and order pages that are displayed to a customer;

FIGS. 6 and 7 depict an embodiment of a gripper bar suspended by a chain as part of a conveyor or assembly line system;

FIG. 8 is a simplified functional block diagram of the gripper bar gripper;

FIG. 9 illustrates a perspective view of the emboss module without the die changer and bolster sub-assemblies integrated therein;

FIGS. 10 and 11 illustrate top and side views, respectively, of the emboss module of FIG. 9 with the die changer and bolster sub-assemblies integrated therein;

FIG. 12 illustrates a more detailed view of the die changer of the emboss module;

FIG. 13 is a diagram illustrating an apparatus that mechanically perfects media;

FIG. 14 illustrates an embodiment of a rotating arrangement to rotate the media to be mechanically perfected;

FIGS. 15-17 illustrate various folds that are common in the industry;

FIGS. 18 & 19 illustrate a perspective view and a top view, respectively, of an adjustable folding station;

FIG. 20 illustrates a regular folding process of a social expression product using the adjustable folding station;

FIG. 21 illustrates a gate folding process of a social expression product using the adjustable folding station;

FIG. 22 illustrates a Z-folding process of a social expression product using the adjustable folding station;

FIG. 23 illustrates an over-wrap sealer apparatus;

FIG. 24 illustrates further details of material handler, one film handler, and side sealer;

FIG. 25 illustrates further details of a film holder;

FIG. 26 illustrates further details of a cross cutter;

FIG. 27 illustrates further details of a side sealer; and

FIGS. 28-33 illustrate a method of sealing and packaging.

### DETAILED DESCRIPTION

The on-demand fulfillment system for the production of customized products (termed “on-demand fulfillment system” herein) enables customers to customize mass produced social expression products, such as social expression cards, using sophisticated manufacturing processes, such as the application of foil, emboss, customized writing, customer photographs and the like, which processes are integrated onto high quality heavy print stock under tight quality control to produce a number of different effects on the finished social expression product. This is accomplished by the present on-demand fulfillment system which provides an automated assembly line that draws production stock from a plurality of sources and can route the production stock through various customer selected manufacturing processes to produce a high quality, yet customized social expression product at a reasonable cost to the customer. While the following description provides an example that relates to social expression cards, it is not intended to limit the scope of the on-demand fulfillment system to this product, since the architecture of the on-demand fulfillment system is also applicable to the production of customized gift wrap, tissue, napkins, paper plates, and any other products, using any of a plurality of media. The social expression products that are described herein are produced on a sheet of card stock and, as they progress through the on-demand fulfillment system, they are termed “partially manufactured social expression products” until they are at the final stage of manufacturing where the social expression product processing is completed. Depending on the product being customized, manufacturing processes such as foil, flitter, flock, bronze, silk-screen, tip-ons can be interposed in the automated assembly line. The automated assembly line is devoid of make ready and is digitally controlled to maintain tight process control and to accommodate specialized production needs. The products produced by the on-demand fulfillment system can be individual products, runs of multiple copies of a product, mixes of these, runs of different classes of products interspersed at the packaging station. Thus, a customer order can encompass multiple products to produce a coordinated set of social expression and/or entertainment materials, which products can be processed in a coordinated manner to enable the shipment of a single integrated product order to the customer.

The user interface to the customer is via the Internet, or wireline based, or wireless communication link, where the customer can select the design and sentiment for the social expression product from the vendor's library of design elements, from other content providers, as well as providing their own creative content input. The customer can customize the product with selected secondary processes using foil, emboss, or other finishing processes. The customer can change fonts, patterns, color, add/delete/edit design elements within the print an/or secondary processes. This on-demand fulfillment system adapts the user interface to match the capabilities of the customer terminal device and is capable of receiving preprocessed customer orders as is described below.

The on-demand fulfillment system works via interconnecting customer terminal devices to one or more processors that serve to provider the user interface and interconnect the customer with the on-demand fulfillment system. The order processor of the on-demand fulfillment system can parse the customer order to identify the resources necessary to process the customer order. The processors schedule and forward the pertinent production data to the various manufacturing elements in synchronization with the movement of the social expression products through the production line. The on-demand fulfillment system also dynamically prices the social expression products as a function of the requested operations and level of personalization and customization. The on-demand fulfillment system can be used for stock reorder by social expression product retail stores, for product ordering by event planning professionals, for production of materials for mass mailings, or by individual customers. In this regard, the customer may be equipped with a customer terminal device that is capable of executing many of the product selection, customization and ordering functions that are described herein in an off-line manner, with the resultant data file being exported to the on-demand fulfillment center for processing.

Architecture of the On-Demand Fulfillment System

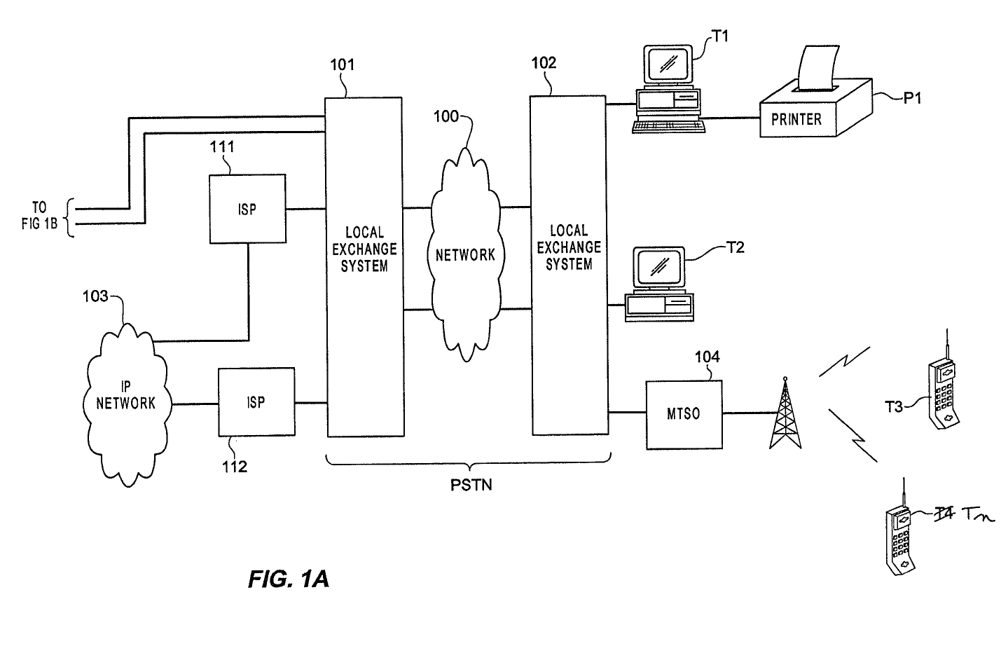

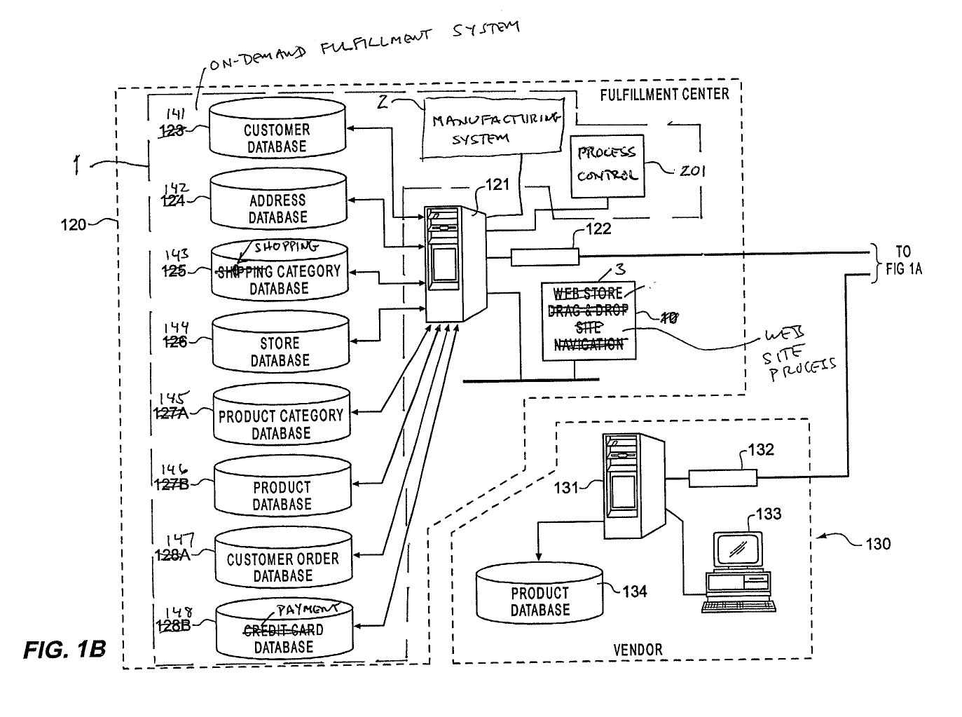

FIGS. 1A-1B illustrate in block diagram form the overall architecture of the on-demand fulfillment system for the production of customized products 1 and a typical environment in which it is operational. In particular, the present on-demand fulfillment system for the production of customized products 1 (termed “on-demand fulfillment system” herein) is incorporated into a fulfillment system 120 that is connected to at least one communication medium, such as the local exchange carrier 101 of the Public Switched Telephone Network (PSTN). This communication medium is connected in well-known fashion to other local exchange carriers 102 via inter-exchange carrier network 100, or to a wireless network 104, or an IP Network, such as Internet 103 via Internet Service Provider 111, or another switched data network, to thereby enable customers to obtain communication connections with the on-demand fulfillment system 1. The customers are typically equipped with a personal computer T1, T2, hand held computing device (not shown), cellular communication device T3, Tn, telephone station set (not shown) or other data interface device, collectively termed “terminal equipment” T1-Tn herein. Alternatively, the customers can access the on-demand fulfillment system 1 via a communication connection from a business intranet (corporate or local area network for example) which serves to interconnect a plurality of the business' terminal equipment via a server.

Another class of customer is termed “vendor” and typically comprises a retail store that processes their orders through the on-demand fulfillment system 1. For example, the vendor site 130 can comprise a terminal device 133, and database 134 that are connected via a server 131 to a communication interface 132. The communication interface 132 is connected to the local exchange system 101, through which the vendor can establish a communication connection to the on-demand fulfillment system 1. A typical connection can be via Internet Service Provider 112 and IP Network 103 to the Internet Service Provider 111 that serves the on-demand fulfillment system 1.

In one embodiment of the system, the fulfillment center 120 on which the on-demand fulfillment system 1 resides, includes: interactive web server software 3, a plurality of servers 121, a plurality of databases 141-148, some of which can, optionally or in part, be part of the on-demand fulfillment system 1 and/or resident on the user's terminal equipment T1. The fulfillment center 120 and the on-demand fulfillment system 1 include various data management processes, some of which are described below. The resources illustrated herein are selected for the purpose of illustrating the concept of the on-demand fulfillment system 1 and are not intended to limit the applicability of this concept to other implementations.

The overall on-demand fulfillment system 1 is modular in that the manufacturing system 2 includes a plurality of core manufacturing functions that are grouped into logical modules and are separable from the assembly line. For example, sheet feeding and vision registration are inherently adjacent and can therefore be paired into a single module. Laser scoring and perfecting (sheet inverting) are also inherently adjacent and can be paired into a single module. Laser cutting and delivery occur on the hex laser drum in another module. These modules can be separated and other modules interposed therebetween to thereby include other secondary processes. For example, emboss and other front decorations can occur between registration and laser scoring. Other processes, such as “tip-on” that are effected on the reverse side of the social expression product can occur after perfecting and before the laser die cut. This modularity enables the on-demand fulfillment system 1 to be configured from a simple feed and cut machine to full decorative machines, that can be configured to include subsystems whose capacity are selected to match the remaining segments of the line. While a linear process is described herein as an illustration of the on-demand fulfillment system 1, the selection of such a paradigm is to simplify the description, since it is evident that the various manufacturing modules can be switchably interconnected to enable the on-demand fulfillment system 1 to dynamically reconfigure the manufacturing process as needed.

Databases

The on-demand fulfillment system 1 includes, in whole or in part or operates in conjunction with: the Customer Database 141, Address Database 142, Shopping Category Database 143, Store Database 144, Product Category Database 145, Product Database 146, Customer Order Database 147, Payment Database 148, and the like. The Customer Database 141 typically stores data that define the customer -customer name, password, account number, payment data, preferences, and the like. The Address Database 142 typically stores data that define the individuals that are the recipients of products purchased by the customers. The Address Database 142 typically stores data that define a name, mailing address, telephone number, associated customer(s), e-mail address, and the like. The Shopping Category Database 143 typically stores data that define the various categories of products that are provided by the various vendors that are served by the on-demand fulfillment system 1 and the identity of the stores in each of these product categories. The stores listed in this database for this customer can be a predetermined selection of stores, or can represent a subset of the plurality of stores that is accessible to the subscriber, with the list being generated automatically by the on-demand fulfillment system 1 based on a customer profile and/or as edited by the customer. The Store Database 144 typically stores data that define the stores served by the on-demand fulfillment system 1 and parsing information that identifies the categories of products that each store includes in their product array, as well as store access information as described below. The Product Category Database 145 typically stores data that define the various sub-categories in a selected Product Category to refine the customer's search for a product. The Product Category Database 145 can be organized on a hierarchical basis to enable the customer to navigate through the hierarchy to a manageable group of products and can include a list of products for each product category. The Product Category can include various parsing parameters, such as price, availability, seasonal nature of the product, and the like. The Product Database 146 typically stores all of the data that relates to each product, including product descriptions, images, product specific ordering data, such as price, discounts, size, color, model number, and the like. The Customer Order Database 147 typically stores data that define the particular products ordered by a customer in a presently active shopping session. The order information typically includes customer name, recipient identification data, product data, delivery dates, shipping information, and the like. The Payment Database 148 typically stores data that indicates the payment options that the customer is authorized to use in purchasing products, including the specific data relating to a Payment purchase authorization session.

While these characterizations of the content and function of the various databases represent typical implementations, it is obvious that the number of databases and their contents are subject to implementation choices, including the selection of a location at which the particular database resides, whether on on-demand fulfillment system 1 or some externally located server, or a combination of sites. In addition, the data stored in the various databases are typically linked to enable each database to perform a data management function that is focused on the type of data stored therein, but the data is linked across all of the databases on a customer basis to enable the customer to execute a shopping session in an efficient manner.

User Interface

The on-demand fulfillment system 1 includes a user interface that enables the customer to execute the order entry function. The user interface can serve various selected communication devices and communication media, such as a customer terminal/Electronic Document Interchange (EDI) via an IP network, wireless device via a wireless network, facsimile/telephone via the telephone network, and the like. The present description uses the example of a user interface that typically executes on a WEB server and serves an individual customer. This user interface provides a sequence of display screens that enable the customer to login to the on-demand fulfillment system 1, review product choices, customize the products, place an order and track the order.

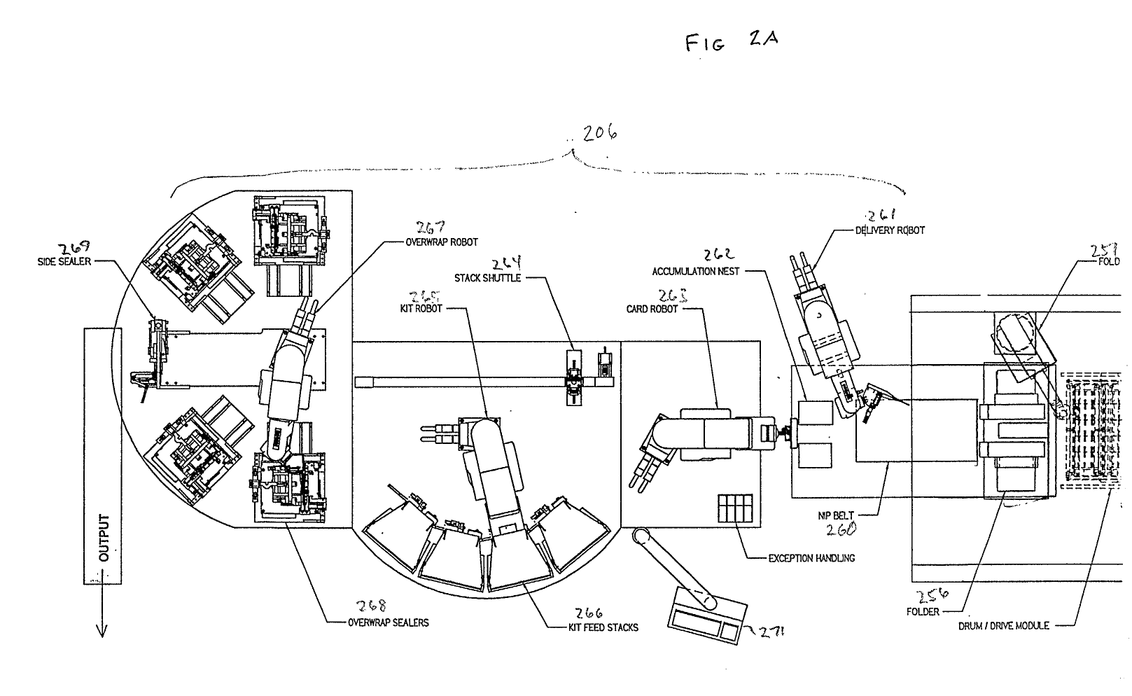

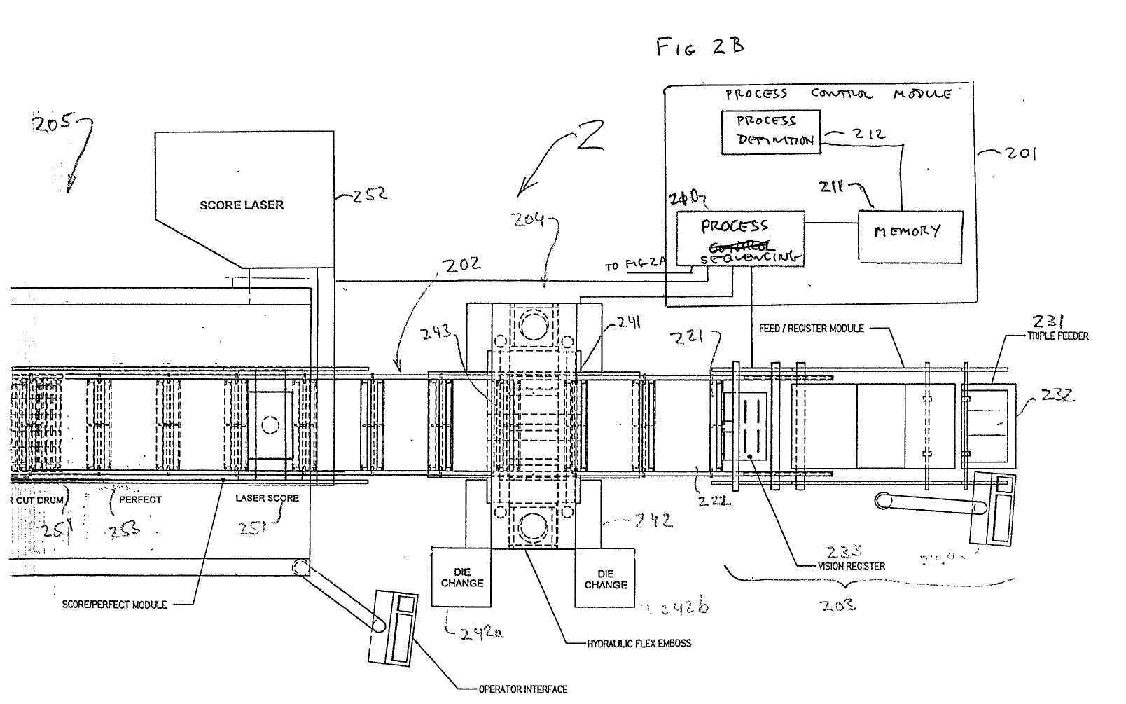

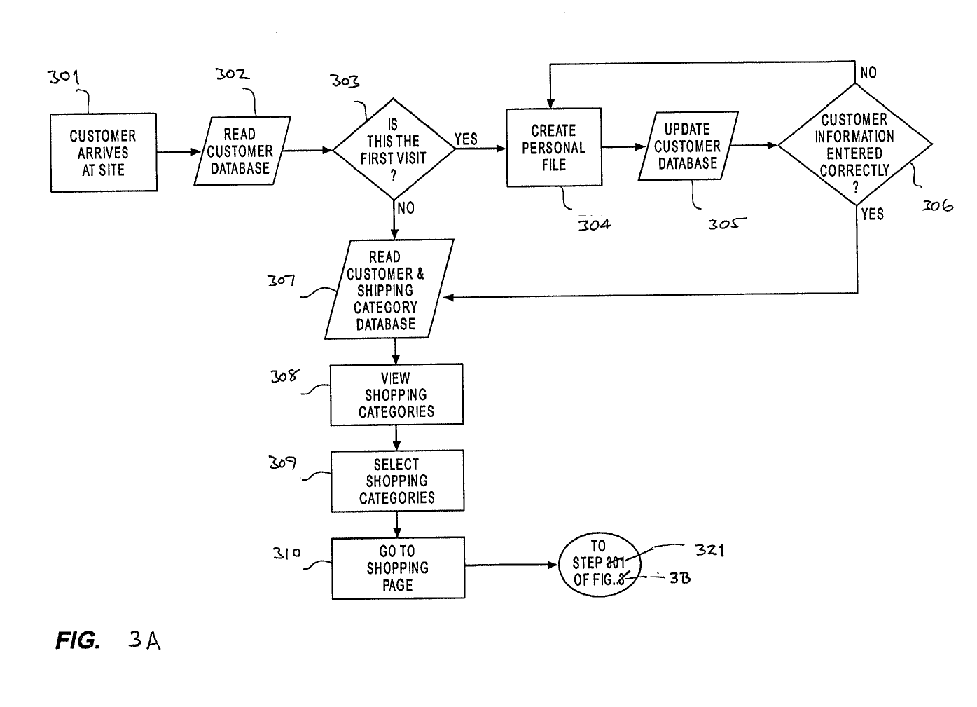

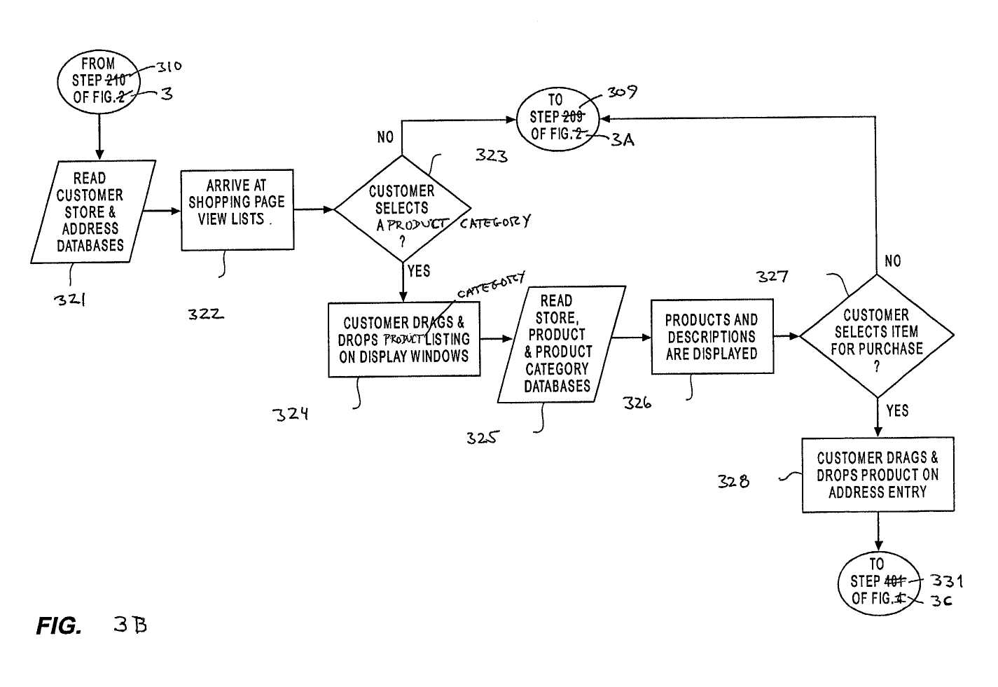

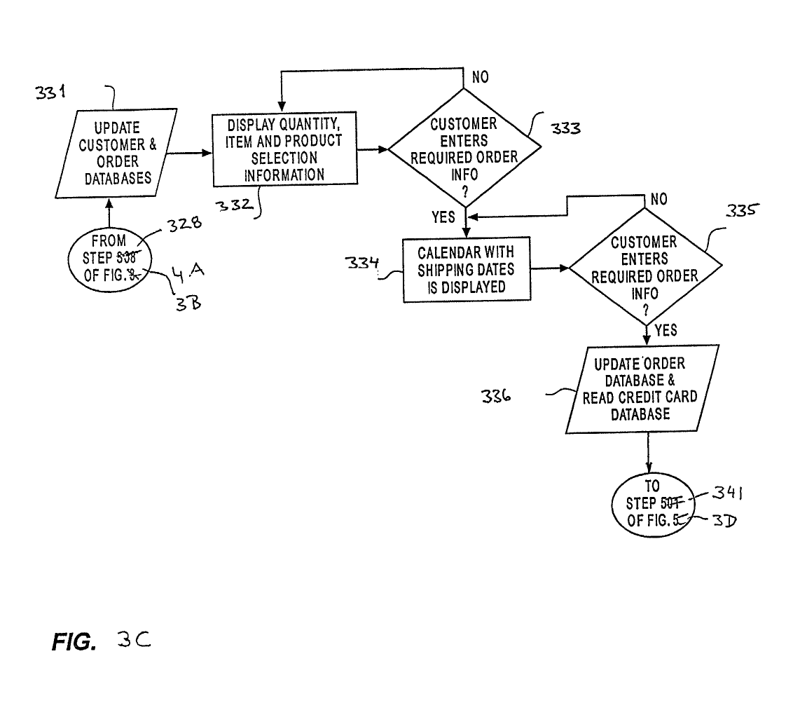

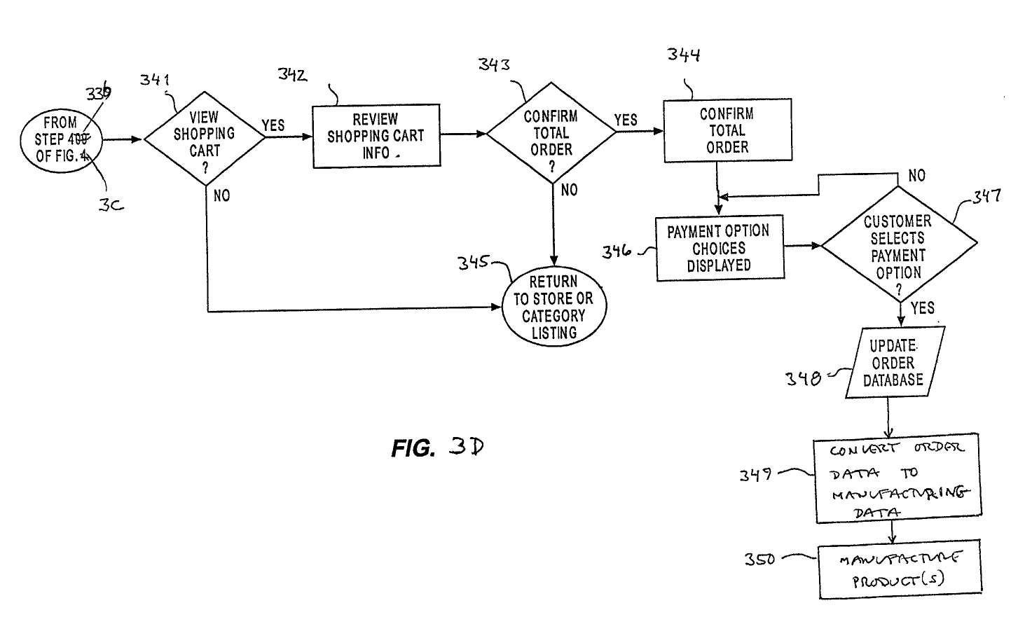

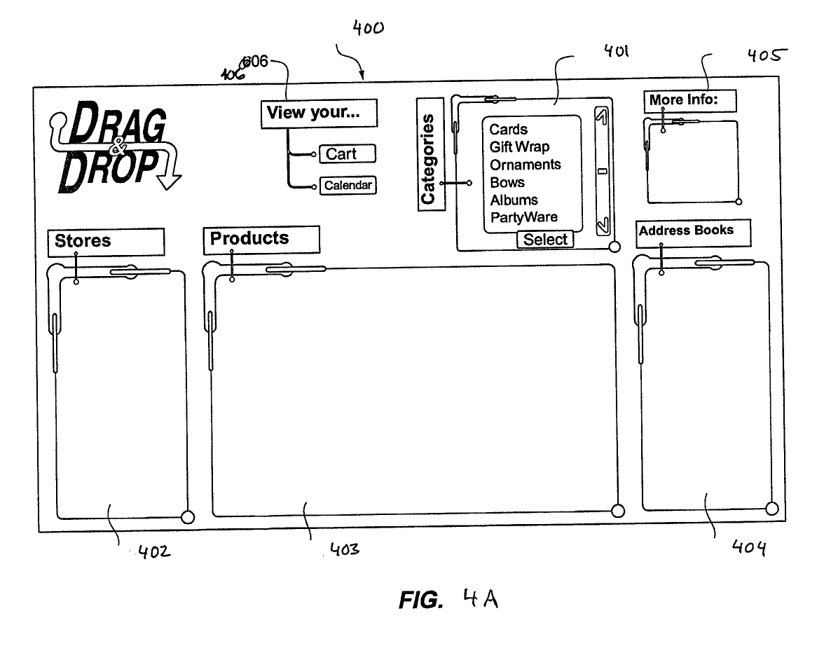

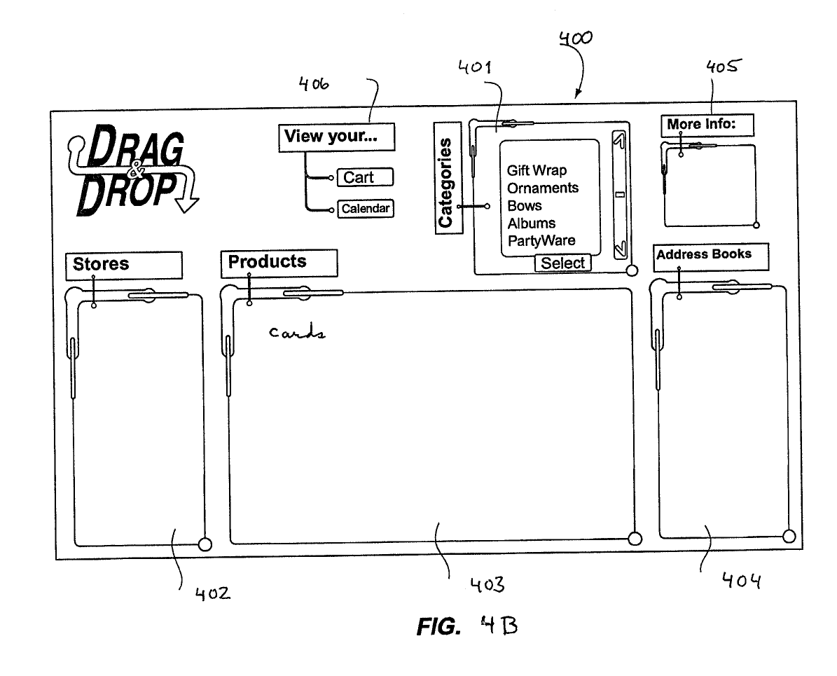

FIGS. 3A-3D illustrate, in flow diagram form, the operation of the on-demand fulfillment system 1 to provide the initial customer login interaction and FIGS. 4A-4B & 5A-5H illustrate in flow diagram form the operation of the on-demand fulfillment system to provide the product order and product customization processes for the customer. In well-known fashion, the customer, using terminal equipment T1, establishes a communication connection to the on-demand fulfillment system 1 via, for example, the IP Network 103 (Internet). In well-known fashion, the customer, using terminal equipment T1, establishes a communication connection to the on-demand fulfillment system 1 via the IP Network 103 (Internet). The on-demand fulfillment system 1 at step 301, as part of the initial connection, presents the customer with a site login page (not shown) as is well-known in the art. The customer inputs data in the requested data entry fields to identify the customer to the on-demand fulfillment system 1. The graphical user interface presents a screen with a plurality of data entry fields, each of which represents a necessary or optional piece of data that is used to identify the customer and provide authenticated access to the on-demand fulfillment system 1.

The on-demand fulfillment system 1 at step 302 reads the existing Customer Database 123 and at step 303 determines from the login data provided by the customer whether this is the customer's first visit to the on-demand fulfillment system 1. If so, processing advances to step 304 where the on-demand fulfillment system 1 creates a personal profile for the customer. This is accomplished by providing the customer with a data entry screen that requests data from the customer to enable the on-demand fulfillment system 1 to populate a profile for the customer. The customer is presented with a page (not shown) that explains the functionality of the site, and allows the customer to personalize the selection and categories of stores the customer wishes to view as well as the operation of the on-demand fulfillment system 1 in terms of the defaults and preferences assigned to this customer.

The customer is also allowed to create a personal address book and optionally enter preference data that indicates the shopping preferences of the customer and/or the various recipients listed in the customer's address book entries. The address book can be populated by uploading data from external sources, such as an address book resident on the customer's terminal equipment T1, or located at external sites and electronically accessible by the on-demand fulfillment system 1. Once the customer has provided the requested data, at step 305 the on-demand fulfillment system 1 updates the Customer Database 141 with this information. The on-demand fulfillment system 1 also at step 306 determines whether the customer has correctly entered the requested data. If not, processing returns to step 304 where the customer is prompted to correct the erroneously entered or incomplete data entries. Once the customer has successfully completed the data entry, or this is not the customer's first visit to the on-demand fulfillment system 1, processing advances to step 207 where the customer's identity is used to retrieve customer profile information from the Customer 141 and Shopping Category 143 Databases.

Order Page Display

After the initial visit, the first page the customer sees at step 308 is typically the Order Page 400 (FIG. 4A), which is a window divided into four main sections 401-404. The first section 401 contains a listing of Product Categories. The second section 402 displays a listing of the product categories the customer has selected during the shopping session, as described below. The third section 403 is for the display of product and product information. The fourth section 404 displays entries from the customer's address book, which entries may be filtered by the Product Category 145 selected. Thus, the customer's address book may be large and to reduce the number of selections presented on the display, the address book entries are reduced to those for whom the customer has indicated a preference in the selected Product Category. Additional sections can optionally be provided, such as section 405 that enables the display of additional information relating to the present state of the shopping session, and section 406 that provides the customer with icons that enable site navigation, such as viewing the shopping cart to see what products have already been selected and/or ordered and a calendar for use in selecting a shipping date or to view data (such as reminders or occasions) relating to events that have been entered by the customer. In addition, icons or “quick keys” or voice input can be used to enable the customer to jump to a selected store rather than navigating the Product Category as described below.

The customer is able to select the category of products, available for purchase through this WEB site, that he wishes to view at step 309, FIG. 3A, by clicking on an icon representative of a selected one of the displayed Shopping Categories, holding down the mouse button and dragging the icon representative of the selected Shopping Category (Cards) to the Products display portion 403 of the Shopping Page 400 display screen as shown in FIG. 4B. In either case, the customer simply uses the graphical user interface functions of point, click, drag and drop (or audible input) to input data, make selections and execute the e-commerce shopping session.

The Shopping Page 400 is configured by the on-demand fulfillment system 1 from data that is retrieved from the Customer Database 141, Product Database 146 at step 321, FIG. 3B. Thus, the on-demand fulfillment system 1 uses the customer profile data retrieved from the Customer Database 141 and the particular shopping category to display a further set of choices for the customer. In particular, a series of screen displays are presented to enable the customer to select product category and then receive a display of the various selections that are available in this category.

The customer is able to view a listing of stores and product categories on the Shopping Page 400 at step 322 and the customer can shop for products based on a store selection or can shop for products directly via this WEB site. Assume that the customer wishes to shop for products directly from this WEB site. When the customer wishes to view a selected product category, the customer clicks on the selected product icon “Cards” at step 323, holds down the mouse button while dragging the selected product icon “Cards” to the product display portion 403 of the Shopping Page 400 as shown in FIG. 4C, and then releases the mouse button at step 324.

Product Selection

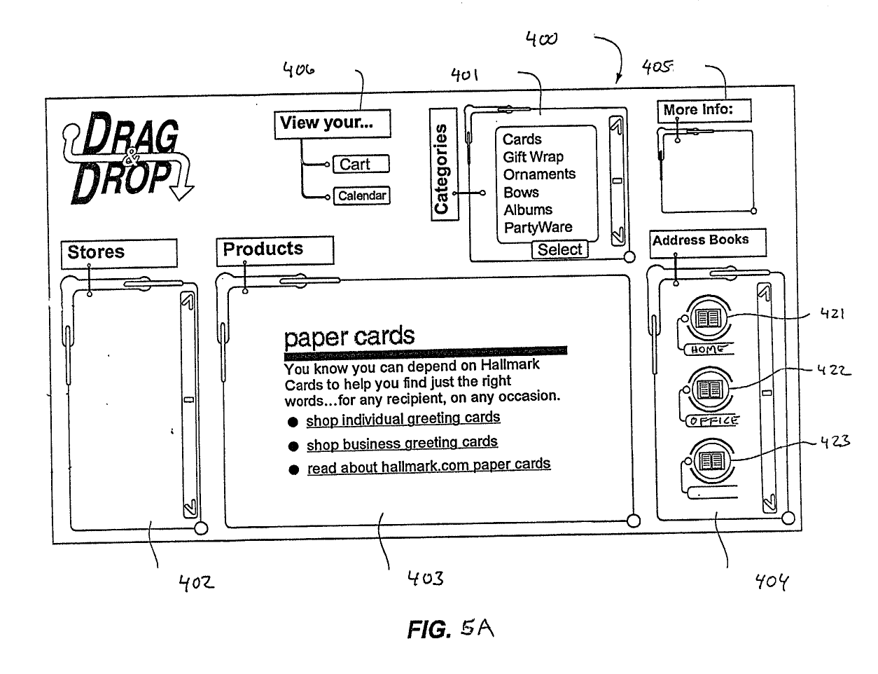

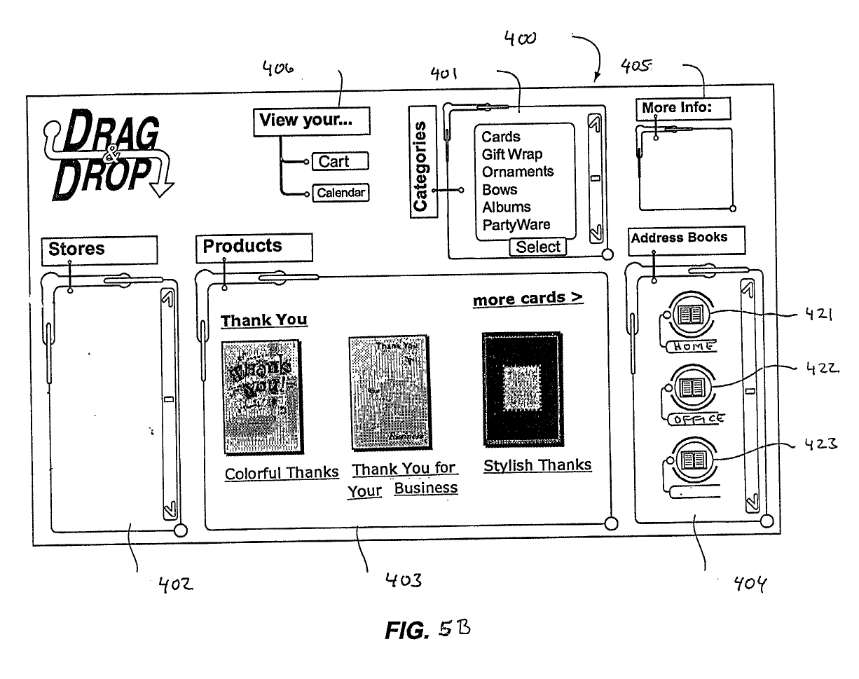

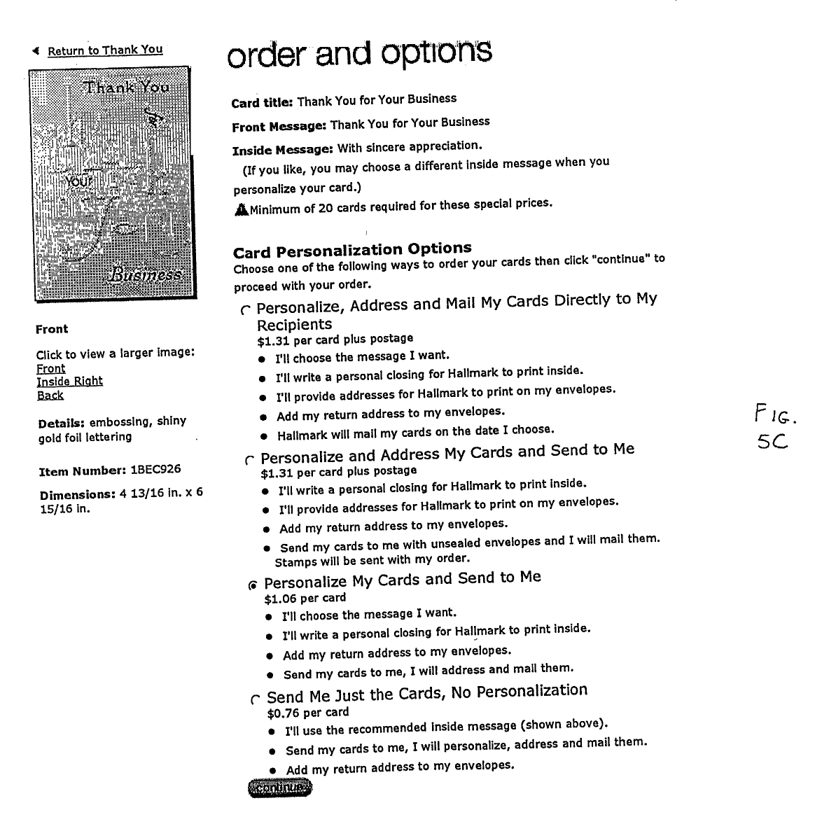

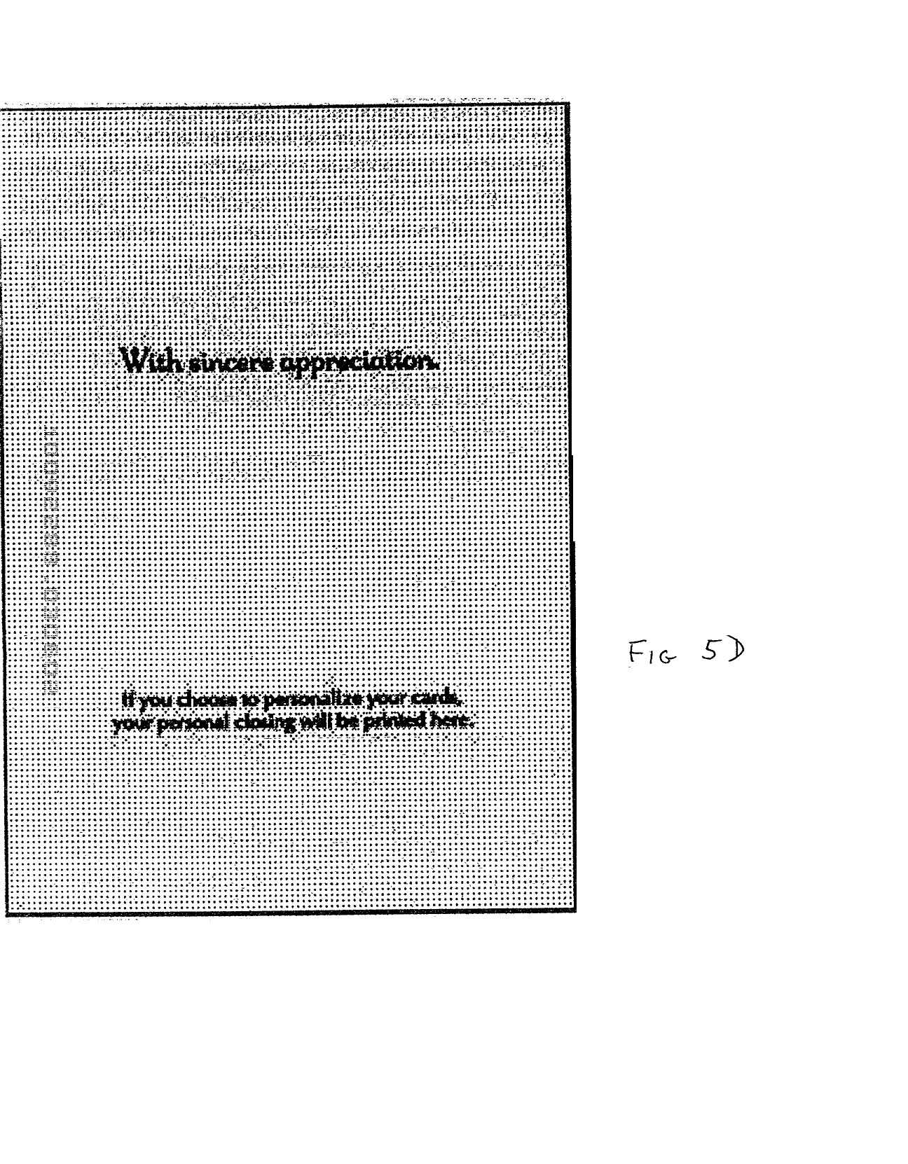

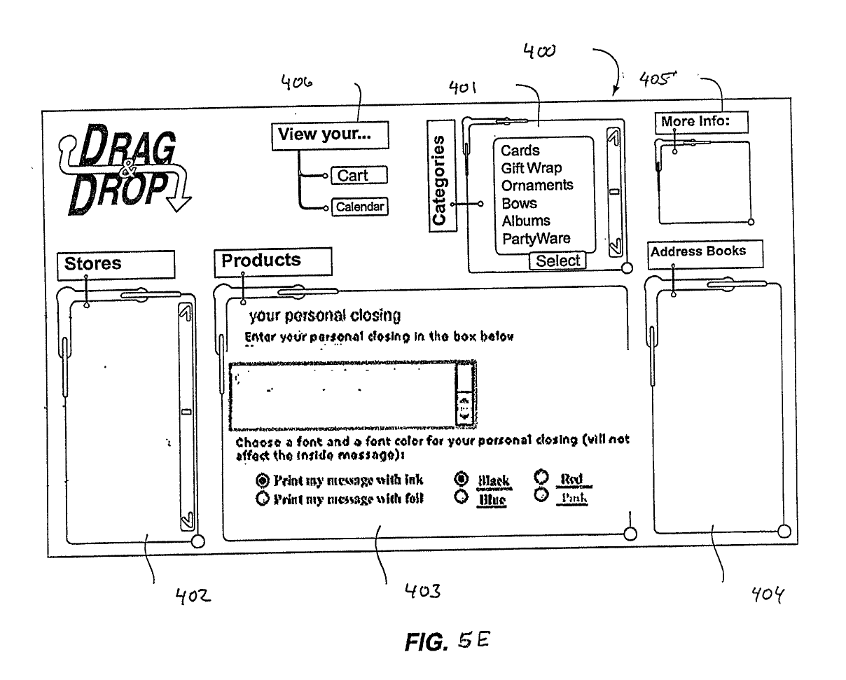

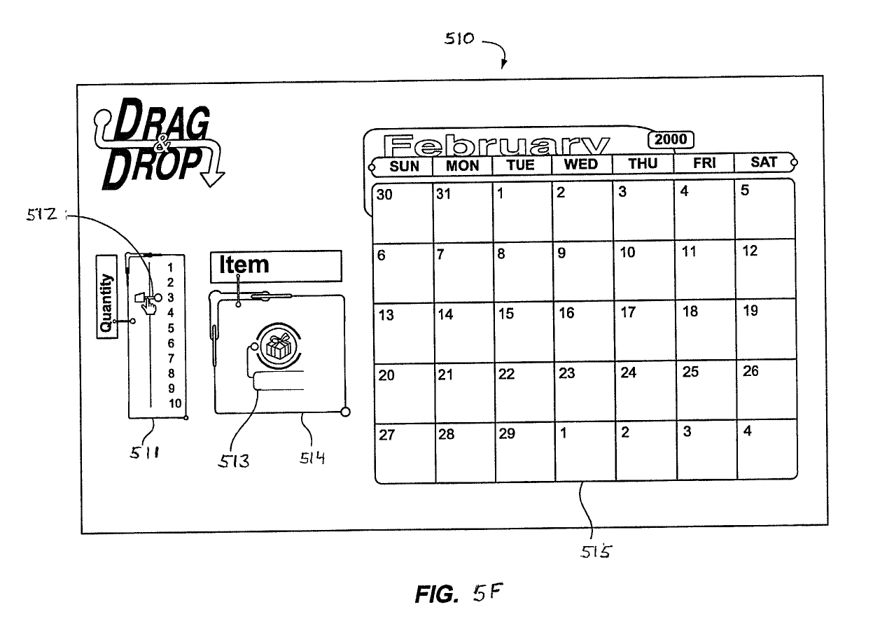

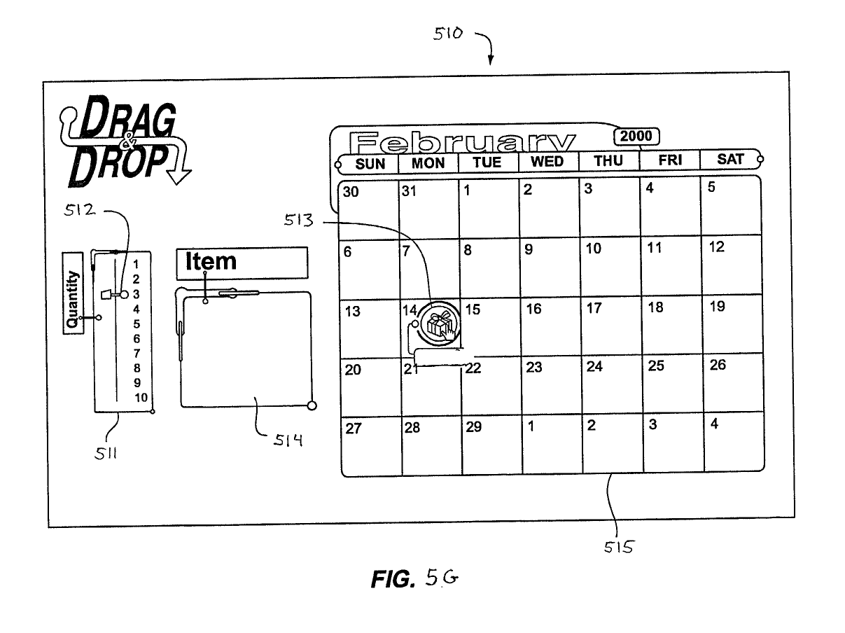

The on-demand fulfillment system 1 then retrieves data from the Store 144, Product Category 145, and Product 146 Databases at step 325 to produce a display of the product categories, and/or product sub-categories, and/or products (typically including pricing information) that are stocked by this WEB site, as shown in FIG. 5A. This store & product selection step may be implemented as two separate steps where the customer first selects a product category, then the on-demand fulfillment system 1 only retrieves product data for that category from the Product Database 146. In addition, the customer profile data is used to retrieve the recipient address data associated with this customer from the Address Database 142 for display in field 404, and may filter the address data by the customer's profile data to reduce the number of entries displayed. For example, the customer may designate certain shopping categories for each of the recipients listed in the address book to simplify the shopping session. Each recipient selected from the Address Database 142 is displayed via an icon, such as icons 421-423, in the fourth section 404 of the Shopping Page 400 as described above.

In the selected category of products (Cards), there are a sufficient number of individual selections that typically a list of product sub-categories would be provided to the customer as shown in part in FIG. 5A. The customer can scroll down this list of product sub-categories and select the one that is of present interest to the customer. For the sake of illustration, the Valentine's Day card sub-category is illustrated as the customer selection, which results in the cards cataloged in this product sub-category being displayed, at least in part as determined by the capability of the display screen, to the customer as shown in FIG. 5B. As noted above, the customer can order an individual customized product or a multiple customized (or standard) product(s). For the sake of this illustration, the latter case is described, where the customer order is for a number of boxes of identical and optionally customized products.

The display of the products in FIG. 5B and their associated descriptions can be based on the customer's selections of Product Category and (optionally) Store, as well as by the products in this category that are stocked by the selected store (the WEB site in this case). The customer's preferences, as stored in the customer profile data, can be used to filter the listing of products that is displayed, or the order of listing products can be varied by the customer profile, or the entirety of the product listing may be provided, as a function of the number of products in the Category. Therefore, the on-demand fulfillment system 1 can perform a mapping function to parse the store inventory into appropriate categories, which are then retrieved as a function of the customer's selection. It is evident that additional filtering can be effected by the use of customer profile information that is stored in the customer database to thereby present the most likely products to the customer.

The location of the Product Database 145 can vary, with one instance the Product Database 146 being part of the on-demand fulfillment system 1 and another instance, the Product Database 134 residing on a data storage device served by the vendor's server 131. In the lafter case, the on-demand fulfillment system 1 can use the customer's data entry session to automatically create a script or other mechanism/process that is used to access the vendor's system 130 and associated Product Database 134. For example, the on-demand fulfillment system 1 can establish a data communication connection via gateway 122 and Local Exchange System 101 via Internet Service Provider 111 to Internet 103 and thence via Internet Service Provider 111 and Local Exchange System 101 to Vendor Server System 130. The Vendor Server System 130 typically includes a gateway 132 and one or more terminal devices 133 for order and data entry. The on-demand fulfillment system 1 can login in to this site and use the customer's data to retrieve product data from the vendor's Product Database 134. Thus, the on-demand fulfillment system 1 functions as the customer's agent, automatically performing the browsing function on the Vendor Server System 130 for the customer. The browsing can also be simultaneously implemented on a plurality of vendor WEB sites, with the results being displayed either seriatim or concurrently on the third section of the Shopping Page. Furthermore, the Product Database could reside on a readable medium, such as a CD-ROM, the subscriber loads into a drive on the customer personal computer T1.

At step 327, the on-demand fulfillment system 1 determines whether the customer has selected an item for purchase by monitoring the actions of the customer. The customer can elect to return to step 308 and select a different shopping category, or to step 323 to select a different store or product category, or can return to step 326 to display additional product descriptions in the presently selected store. The selection of the Shopping Category or Stores or Product Categories or Products can be effected as described above by simply clicking on the appropriate icon and dragging it to the appropriate section of the Shopping Page 400 or clicking on the section title.

The customer selects an item for purchase at step 328 by selecting a displayed product icon 501, holding down the mouse button, dragging the selected product icon 501 to the fourth portion 404 of the Shopping Page screen 400 and dropping the product icon 501 on an address entry 422 that is displayed in the customer's address book. For example, the addresses can represent various retail stores that a vendor is stocking with inventory or, as in this case, a location (home, office, and the like) where an individual is having a number of boxes of the selected product delivered. An example would be invitations to a party that are shipped to the customer's home, and which invitations need to be customized in terms of the information contained therein and possibly the finish applied to the invitations.

Product Selection and Shipment

Once the customer clicks on a product icon 501 and drags the product icon 501 to an address book entry 502, the on-demand fulfillment system 1 updates the Customer 141 and Customer Order 147 Databases to reflect the customer's selection. The customer is then presented with a series of screens to complete this portion of the order. At step 331, the on-demand fulfillment system 1 displays the product, quantity data, item description data, and any other optional product selection data (such as color, size, price, etc) that is required to complete the product selection.

As shown in FIG. 5C, the product specifics and various customization and product delivery options are displayed to the customer. In this case, the customer wishes to customize the product and have them delivered to the customer's home. This selection of the product customization with delivery to the customer option causes the display of FIG. 5D to be presented to the customer, where the personalization options for this selected product are indicated and the customer can input data representative of the personalization, such as the message contained in the invitation, the type of finish provided on the invitation, and the like. The message customization is then displayed to the customer as shown in FIG. 5E for confirmation by the customer. The customer can then, at step 332, enter the required order information, specifying the particulars of the product for the order. For example, the customer, as shown in FIG. 5F can select a quantity in field 511 by placing the mouse pointer on the quantity icon 512 and holding down the mouse button while dragging the quantity icon 512 to the desired number, such as 3 boxes as shown. FIG. 5G then indicates the ability of the customer to indicate, at step 333, the desired shipping date by dragging the order icon 513 displayed in the Item field 514 onto a selected date displayed on the calendar 515. After the customer selects a shipping date, as determined at step 334, the calendar window closes and the on-demand fulfillment system 1 determines at step 335 whether the necessary order information has been entered, then updates the Customer Order 147 and Payment 148 Databases at step 336.

When the customer has finished shopping for this product, the on-demand fulfillment system 1 displays the order information to the customer as shown in field 521 in FIG. 5H at step 341, which results in the shopping cart information being displayed at step 342 and reviewed by the customer. The customer can then at step 343 check out by clicking on the Check Out button 523 and advancing to step 344 as described below. Alternatively, the customer can select other products for purchase for this recipient or can select the same product for other recipients or can select other products for other recipients at this juncture before proceeding to the final order processing steps. The customer can accomplish this by clicking on the Buy More icon 522, which brings the customer back to the Shopping Page 400 illustrated in FIG. 4A to proceed at step 306 with additional purchases in this shopping session.

If the customer does not return to the Shopping Page 400, the on-demand fulfillment system 1 opens a window (not shown) at step 346 to display payment options, retrieved from Payment Database 148. The customer is asked at step 347 to enter or select the required information, which is then verified and submitted as an order transaction by the on-demand fulfillment system 1 updating the Customer Order Database 147 at step 348.

In this check out process, there are a number of possible variations. The customer can be presented with an invoice on a per vendor basis, or can receive a single composite invoice for all purchases, or can receive an invoice on a per recipient basis, as selected by the customer pursuant to the check out process or identified in the customer profile. Therefore, the customer can return to different stores and shopping categories as described above, or can shop for all purchases in a single store, then check out from that store before shopping in other stores in the same shopping session. This variety of options are provided by the on-demand fulfillment system 1 by enabling the customer to simply use the graphical user interface functions of point, click, drag and drop in whatever sequence the customer desires. Furthermore, the customer can terminate their session at any point and store the session data for later use in a follow up session where the customer completes the transaction.

Once the customer has completed their social expression product ordering session, at step 349, the on-demand fulfillment system 1 converts the customer provided social expression product definition data into the data required to operate the manufacturing system 2. In particular, each social expression product that is available in the catalog of products typically has a data file or set of data files associated with its identification information, which data files define the manufacturing process. This includes selection of media, manufacturing steps and the like. The customer provided customization data represents options in corresponding ones of these data files that define manufacturing options. Thus, the process control module 201 converts the customer order data into the necessary set of manufacturing process control data files for use in manufacturing at step 350 the customer-selected social expression products. The processing of each order can be coordinated by the process control module 201 so that similar social expression products are manufactured in succession to more efficiently operate the manufacturing system 2 and reduce the need for resetting options on the manufacturing modules in the manufacturing system 2.

Vendor Orders

The above example illustrates the operation of the on-demand fulfillment system 1 in serving an individual customer. The vendor, noted above, can also input order data in a manner that is analogous to that described for the individual customer. It is an option to implement a significant portion of the above-described functionality on the vendor's computer system to thereby enable the pre-processing of the product selection, product customization, order creation functions and minimize the amount of time required for the vendor's computer system to transmit order data to the on-demand fulfillment system 1. Thus, the vendor's computer system can create the order for the customized social expression products and optionally create the parsed data files that are used by the various manufacturing processes, which are then uploaded to the on-demand fulfillment system 1.

Architecture of the Manufacturing Portion of the On-Demand Fulfillment System

Social expression products are manufactured in a variety of sizes, shapes and styles. Production runs of conventional social expression products, such as social expression cards, are in the thousands or tens of thousands of cards and the production run generally includes at least the steps of printing, scoring, cutting, folding and packaging the cards. Additional steps may be included to provide more sophisticated manufacturing processes, such as the application of foil, emboss, die cut, customized writing, customer photographs, insert addition, envelope addressing and stuffing, and the like, that are the hallmark of professional quality social expression cards. Each of these steps requires a substantial amount of setup time and the involvement of highly skilled operators to make the production line ready. However, there is a desire to be able to produce social expression products on-demand in smaller runs, from a single social expression product to a few dozen social expression products of a particular design. Present manufacturing techniques make such small runs uneconomical to produce. This is especially a problem in the packaging function. There presently does not exist any on-demand plastic wrap packaging systems. Packaging equipment must be set up and configured to make a package of a particular size and shape. Once the setup is accomplished, it is necessary to run a large number of social expression products through the system to make the setup costs economically justified.

FIGS. 2A & 2B illustrates additional details of the present on-demand fulfillment system 1, consisting of the manufacturing system 2 portion, which is shown as a series of inter-connectable manufacturing modules, each of which implements a particular social expression product manufacturing operation. The modules can be disabled in the manufacturing of a run of social expression products such that the partially manufactured social expression products received at that manufacturing module from a preceding manufacturing module are simply passed through the module without processing, or the run of partially manufactured social expression products can be diverted around a particular manufacturing module to the next successive manufacturing module. Thus, the on-demand fulfillment system 1 can route the partially manufactured social expression products to a selected series of manufacturing modules, as determined by the definition of the social expression product by the customer. A number of these manufacturing modules are described herein to illustrate various features of a typical implementation of the on-demand fulfillment system 1. It is expected that each of the manufacturing modules is program controlled and receives its particular set of instructions from the process control module 201, preferably in the form of a data file that is formatted specifically for the selected manufacturing module.

The on-demand fulfillment system 1 includes at least one process sequencing module 210 that operates under control of program instructions that are stored in a memory 211 to control the operation of the various manufacturing modules that are used to produce a social expression product. The process sequencing module 210 is connected to the various program controlled manufacturing modules, and only a few of these connections are shown in order to simplify the FIGS. 2A & 2B. The process definition module 212 of the process control module 201 retrieves the customer's product order which is received as described above and parses the order into component elements, each of which relates to a particular manufacturing module that must be activated or bypassed in a determined order to produce the product that is defined by the customer. The social expression product definition and order entry data can be parsed by the process definition module 212 into a plurality of files, each directed to a one of the plurality of manufacturing modules that comprises the manufacturing portion of the on-demand fulfillment system. In this manner, the files can be exported to the plurality of manufacturing modules in a manner that is temporally coordinated with the progression of the partially manufactured social expression product through the automated assembly line. In addition, the process sequencing module 210 schedules the implementation of the manufacturing process in order to make efficient use of the manufacturing resources. Thus, similar product orders can be queued so that the manufacturing processes are used repeatedly to process orders, thereby minimizing the changes to the manufacturing process.

The on-demand fulfillment system 1 integrates the various manufacturing modules via the use of a transport mechanism 202 that serves to interconnect the various manufacturing modules and transport card stock and partially manufactured social expression products between manufacturing modules. As can be seen from the following description, the transport mechanism 202 must not only deliver the partially manufactured social expression product to successive manufacturing modules, but it must also synchronize the delivery of the partially manufactured social expression product with the operation of the manufacturing module. In this regard, the transport mechanism 202 should be self-adjusting to automatically compensate for wear in the elements used to implement the transport mechanism 202 and variations in the manufacturing modules and in the implementation of the transport mechanism 202 Furthermore, the transport mechanism 202 must securely grip the partially manufactured social expression product and accurately orient the partially manufactured social expression product. Finally, the transport mechanism 202 should interface with the various manufacturing modules to minimize the repositioning of the partially manufactured social expression product to ensure accuracy of the registration of the partially manufactured social expression product with respect to the various manufacturing modules.

The transport mechanism 202, at one end thereof, can connect to a sheet feeder 203 that comprises a source of card stock, typically stored in a plurality of bins 232, and presented to a sheet feeder mechanism 231. The process control module 201 activates sheet feeder mechanism 231 to retrieve a sheet of card stock from a selected bin 211 and present the retrieved sheet of card stock to a perfecting gripper 221 that is part of the transport mechanism 202 where the gripper 232 in conjunction with vision register 233 orient and secure the sheet of card stock in the gripper 221. An operator terminal 234 is typically provided to enable an operator to monitor and control the operation of the sheet feeder 203.

Typically, sheets of preprinted social expression product stock (partially manufactured social expression products) are stored in the sheet feeder mechanism 231 which uses a bar code scanner that reads the Cell ID of the sheet of preprinted social expression product stock that is loaded into the sheet feeder mechanism 231. The process control module 201 knows which partially manufactured social expression product is coming through the production line, based on the data received from the bar code scanner. The process control module 201 notifies all processing elements in the production line that the partially manufactured social expression product, with its selected attributes, is being processed, the order of manufacturing steps in the product flow, and the process that is to be implemented in each manufacturing module. Alternatively, the sheet feeder can be an output processing device that is connected to the output of a high quality multi-color printer (not shown) which takes social expression product stock, prints the selected materials on this social expression product stock and outputs the printed sheets of partially manufactured social expression products to the production line via the sheet feeder mechanism 231.

Once the partially manufactured social expression product is printed, the process control module 201 activates the transport mechanism 202 to deliver the partially completed social expression product to various manufacturing modules, a plurality of which are shown in FIGS. 2A, 2B. These manufacturing modules are typical of those that would be used in manufacturing a range of social expression products, but this illustration is simply a typical embodiment and is not intended to limit the number and type of manufacturing modules that can be used to implement the on-demand fulfillment system.

One manufacturing module is the emboss module 204 which is activated by the process control module 201 to emboss a portion of the partially manufactured social expression product. Conventional emboss modules typically use male and female dies configured in a predetermined shape and style. A sheet of material, such as paper or social expression product stock, is positioned in between the male and female dies as the two dies are pressed together in a complimentary manner, thereby forming an emboss in the material. In other emboss modules, a flexible counter is used in lieu of the male die. The female die is pressed against the sheet of material that rests on the flexible counter, which itself is positioned on a bolster for receiving the sheet of material and the die. The emboss module 204 shown as part of the present on-demand fulfillment system 1 uses an automated die changer that changes dies with minimal operator effort and that automatically registers dies. This emboss module 204 can accommodate both emboss dies and foil dies, switching from one to the other. The emboss module 204 has a frame 241, a die changer sub-assembly 242 and a bolster sub-assembly 243. The die changer sub-assembly 242 includes at least a pair of rotatable die changers 242a, 242b for automatically registering dies therein. The bolster sub-assembly 243 includes a counter and panels for receiving the sheet of material and the die. When the die changer 242 and bolster sub-assemblies 243 are integrated into the frame 241, the dies and bolsters can be automatically changed to provide for a more efficient and scalable emboss module 204 The die changer sub-assembly 242 includes a pair of rotatable die changers 242a, 242b, that can be rotated both clockwise and counter-clockwise directions.

During the manufacture of printed media, the media may be processed on both sides. For example, a social expression product may be embossed on a first side, scored on the opposite side, then cut on the first side, and finally folded along the scored side to form a greeting card. To simplify the manufacturing process, a single sheet partially manufactured social expression product is mechanically turned so that it is processed on both sides. The mechanical turning is termed “perfecting”. The on-demand fulfillment system 1 therefore typically includes a score/perfect module 205 to perform these operations. The score/perfect module 205 includes a laser scoring apparatus 251 that uses a score laser 252 to score the partially manufactured social expression product, as defined by the process control module 201, which is then transported by the transport mechanism 202 to the perfect module 253 for mechanical turning, as controlled by the process control module 201. The turned partially manufactured social expression product is then cut along a predetermined cut line and delivered by fold robot 257 to the card folder 256 for folding in a predetermined pattern, pursuant to the data file information provided by the process control module 201.

Also, the on-demand fulfillment system 1 includes a packaging module 206 that serves to package the run of social expression products into units that are defined by the process control module 201. The packaging module 206 includes mechanisms for card stacking, sorting, wrapping and output. The packaging module 206 uses a delivery robot 261 to retrieve folded cards from the output of the folder 256 and places these cards in one or more accumulation nest bins 262. When a predetermined number of cards have been placed in an accumulation nest bin 262, card robot 263 transports the accumulated cards to stack shuttle 264 which makes the stack available to kit robot 265. A plurality of kit feed stacks 266 is provided to enable kit robot 265 to sort the card stacks until the stacks are ready to be delivered to the wrapping apparatus. The wrapping apparatus comprises an article handler robot 267, a plurality of film handlers 268, and a side sealer 269. Each film handler 268 includes a film roll holder for holding a film roll. Each film has a length and a width, wherein the film is folded along its length to have an open side and a closed side. The film rolls each have a different width between the respective open and closed ends of the films they carry. Each film handler 268 further includes a film holding arrangement positioned to receive film from the film roll holder. The film holding arrangement is adapted to hold open the film along its open side. Finally, each film handler 268 includes a cross cutter positioned to receive film from the film holding arrangement. The cross cutter includes an end cutting and sealing blade positioned traverse to the length of the film and adapted to cut and seal an end of the film adjacent an end of an article. The article handler 267 is positioned adjacent the film handler 268 and is adapted to deliver an article to a film handler 268 selected to have a film width greater than the width of the article and to insert the article into the film holding arrangement of the selected film handler 268 through the open side of said film and move the article and film past the cross cutter, whereupon the end cutting and sealing blade is actuated to cut and seal said film adjacent an end of the article. The side sealer 269 is positioned adjacent the article handler 267. The side sealer 269 includes a side cutting and sealing blade positioned to cut and seal an open side of the film adjacent a side of the article. The side sealer 269 includes a gripper positioned to receive an article from the article handler 267 with the film being sealed on either end of the article. The gripper is arranged to position the side of the article adjacent the open side of the film adjacent the side cutting and sealing blade. The side cutting and sealing blade is actuated to cut and seal film closely adjacent the side of the article.

Finally, the packaged and wrapped cards are delivered by side sealer to an output module 270 which serves to transport the package of cards to a shipping location where the cards are further packaged for shipping to the designated destination.

Transport Mechanism

The transport mechanism consists of a mechanism that serves to accurately position and securely grip the partially manufactured social expression products, which mechanism is transported to the various manufacturing modules to enable the processing of the partially manufactured social expression products at each manufacturing module. The transport mechanism must therefore interface with each manufacturing module in a manner to enable the manufacturing module to perform its designated processing of the partially manufactured social expression product without setup. The following description represents one such transport mechanism for use with a plurality of the manufacturing modules of the on-demand fulfillment system 1. In addition, the transport mechanism can use a plurality of specialized robots to transport partially manufactured social expression products and completed social expression products between manufacturing modules.

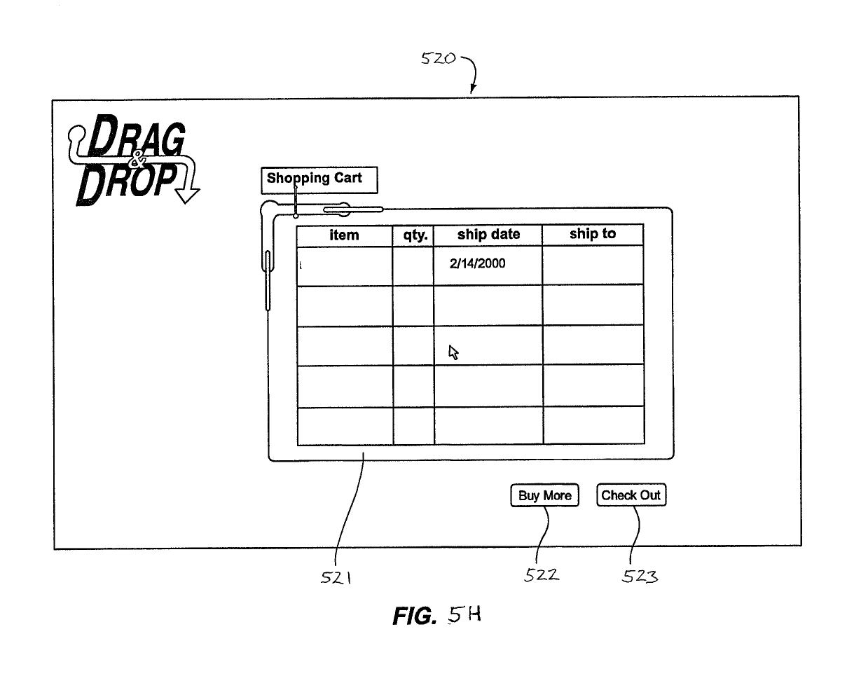

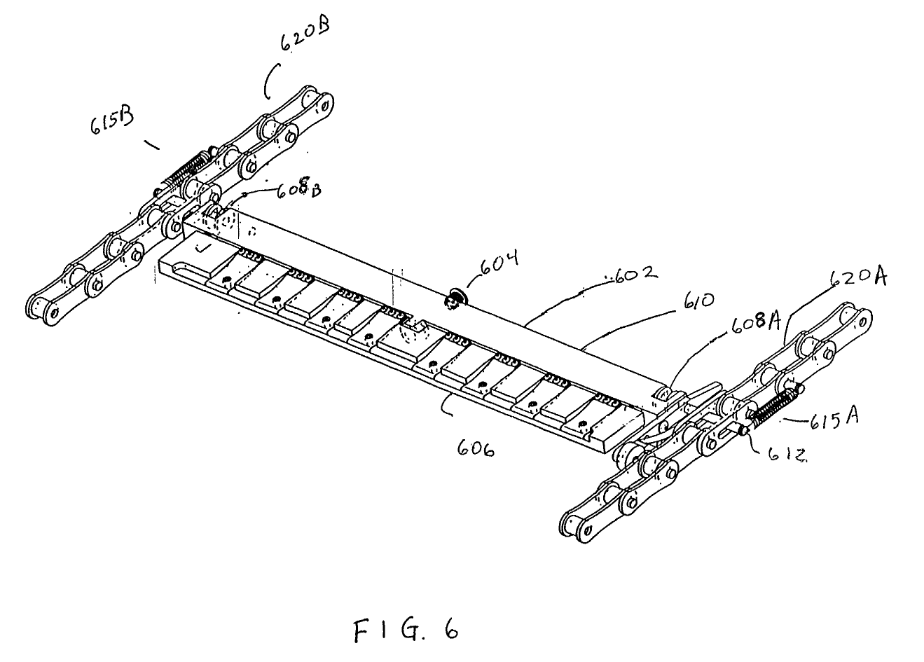

The transport mechanism 202 as shown in part in FIGS. 6-8, includes a plurality of gripper bars 610 that are connected to and transported by a chain mechanism 620 along a predetermined path through a plurality of manufacturing modules. One or more drive motors 222 drive the chain mechanism in conventional fashion along a predetermined path. The gripper bars 610 are spring loaded to enable location independent registration. Due to wear in the chain mechanism 620 and mis-registration between the manufacturing modules, the spring loaded gripper bars 610 are self correcting in that they are not rigidly connected to the chains 620 but are floating in a longitudinally oriented slot through the chain links. The gripper bar 610 is biased by springs 615 toward the direction of travel so that when the gripper bar 610 contacts a stationary dog at a registration station which is part of a manufacturing module, the gripper bar 610 floats independent of the stopped location of the chain links. Thus, the gripper bar 610 is precisely registered with respect to each successive manufacturing module regardless of the chain position. The chain 620 therefore performs a transport function, not a registration function.

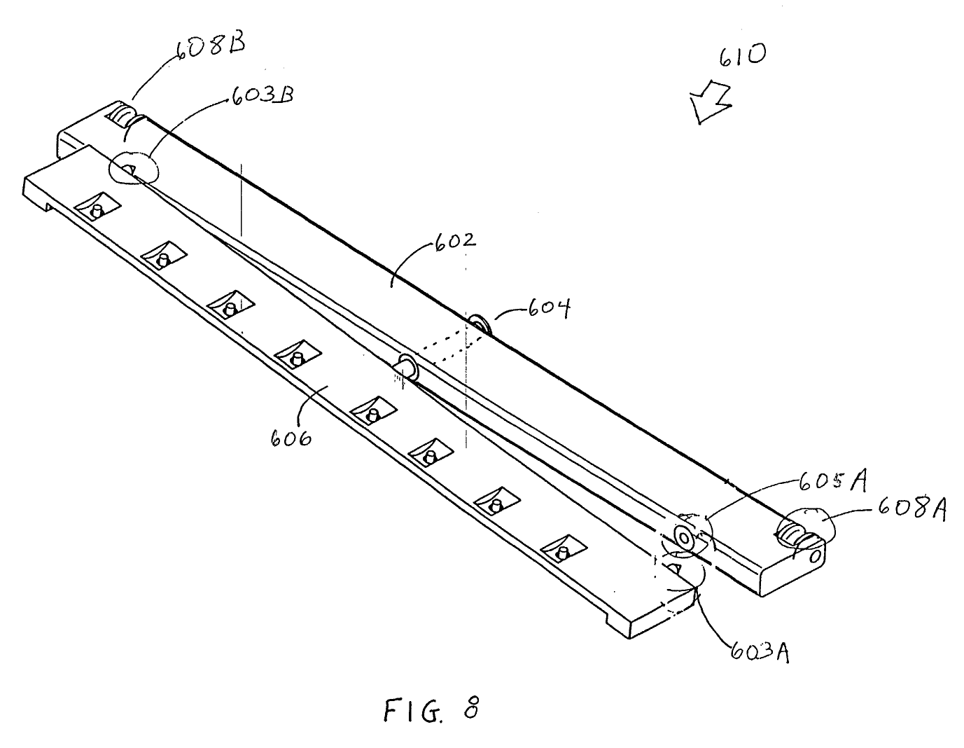

FIG. 8 is a simplified functional block diagram depicting gripper bar 610. Gripper bar 610 is designed to hold partially manufactured social expression product, and convey partially manufactured social expression product from one manufacturing station to another manufacturing station along a linear media processing/assembly line. Gripper bar 610 comprises a body 602, and a rotatable part 606 mounted to the body 602. The body 602 is the part of the gripper bar 610 that moves linearly through an assembly line conveyor. The rotatable part 606 is designed to hold the partially manufactured social expression product being processed. In some embodiments, the rotatable part 606 holds the partially manufactured social expression product by exerting pressure on the partially manufactured social expression product, clamping the partially manufactured social expression product between rubber teeth. The mounting connection between the body 602 and rotatable part 606 may be performed by any rotary joint 604 known in the art that allows the rotatable part 606 to rotate, including a rotary union, ball-bearing, or axle. In some embodiments, the rotary joint 604 is placed in the center of the body 602 and the rotatable part 606, so that the rotatable part 606 is always centered along the axis of the rotary joint 604 and the body 602. When the rotatable part 606 is rotated 1800 along the rotary joint 604, while holding the partially manufactured social expression product, the partially manufactured social expression product is perfected. Rotatable part 606 and body 602 may also have detents to lock the rotatable part 606 in a fixed position relative to the body 602. For example, as shown in FIG. 8, the rotatable part 606 has male detents 603A-B, while the fixed part 606 has corresponding female detents 605A-B. It is understood, by those known in the art, that either part may have one or more of such male detents 603 and corresponding female detents 605. The male detents 603 may be spring-actuated, so that a light amount of pressure along the rotatable part 606 does not rotate the rotatable part 606. In such an embodiment, a known amount of threshold pressure may be required to rotate the rotatable part 606.

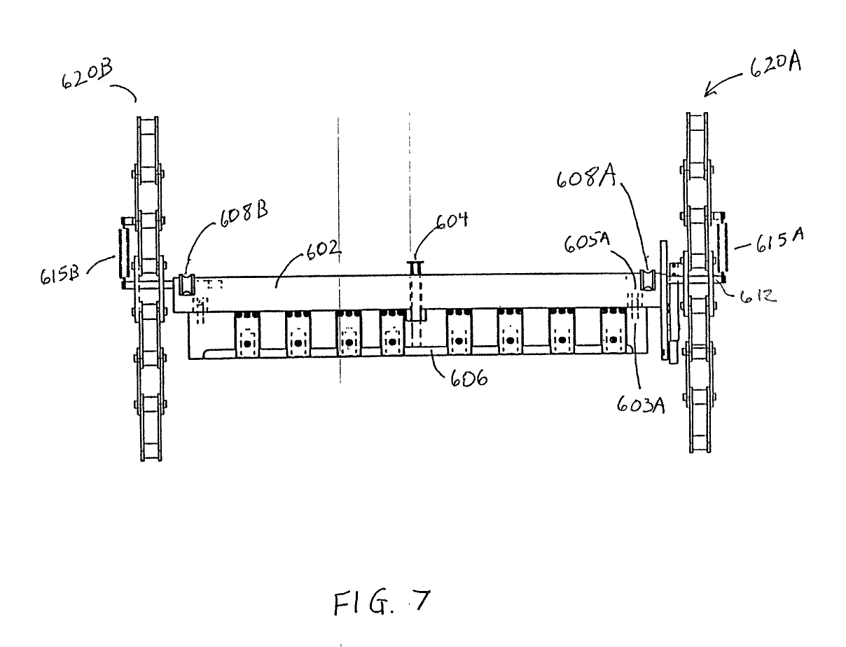

FIGS. 6 & 7 depict an embodiment of a gripper bar 610 suspended by a chain 620 as part of transport mechanism 202. FIG. 6 illustrates the body 602 of gripper bar 610 positioned at an angle, while FIG. 7 illustrates the same gripper bar 610 as viewed from the above. As shown in FIGS. 6 & 7, a pair of springs 615A & 615B forward biases the body 602 of gripper bar 610, via axel 612 in horizontally oriented slots that are formed in selected links of chains 620A-B. Stops are provided at each manufacturing module where the partially manufactured social expression product is processed. Examples of manufacturing modules include, but are not limited to, locations where the partially manufactured social expression product is printed, scored, cut, embossed, or otherwise treated. The stops located at the various manufacturing modules engage rollers 608A-B on the body 602 of the gripper bar 610 to stop the gripper bar 610 at a precise location. The stopped position may be independent of the position where the chain stops because of the forward bias imposed by the springs 615A & 615B.

One aspect of indexing a flighted gripper bar 610 is the need to bring the partially manufactured social expression product into contact with a flat platen in a manufacturing module. The path of the gripper bar 610 must clear the platen but the partially manufactured social expression product must also be brought to the platen during the process dwell. In existing systems, the platen is moved to the sheet of partially manufactured social expression product and into the line of travel during the process dwell, then moves away from the sheet of partially manufactured social expression product during the gripper index process. In the present on-demand fulfillment system 1, the body 610 of gripper bar 602 is carried via a round axle 612 near the leading the leading edge of the gripper bar 610. This creates a pivot point at which the gripper bar 610 can freely tilt upward or downward. After passing over or under the stationary platen, the gripper bar 610 can be tilted to bring the sheet of partially manufactured social expression product into contact with the platen, thereby eliminating the need to move the platen apparatus. In the present on-demand fulfillment system 1, this tilting attribute is used at the product feeder 231, vision registration 233, emboss, laser score 251 and the laser cut hex drum 254.

Registration System

When the partially manufactured social expression product is placed in the gripper bar 610, two registration cameras in vision register 233 note the position of the partially manufactured social expression product via the location of registration marks imprinted on the social expression product stock that is used to implement the partially manufactured social expression product. Positioning adjustments, in for example the X-axis, Y-axis and ø-axis directions, are automatically made to the partially manufactured social expression product to properly align the partially manufactured social expression product in the gripper bar 610. The gripper bar 610 then locks down on the partially manufactured social expression product and is drawn by the chain drive mechanism 620 down the production line from manufacturing module to manufacturing module. The on-demand fulfillment system 1 uses spring loaded interlocks to assure that the gripper bar 610 remains in exact registration as it moves down the production line, as noted above.

Emboss Station

The emboss module 204 includes a plurality of dies which are automatically loaded and positioned for use in embossing the selected partially manufactured social expression product with the customer selected imprint for the partially manufactured social expression product. The process control module 1 defines the pressure, heat and dwell applied to the die as a function of the social expression product definition generated for this product.

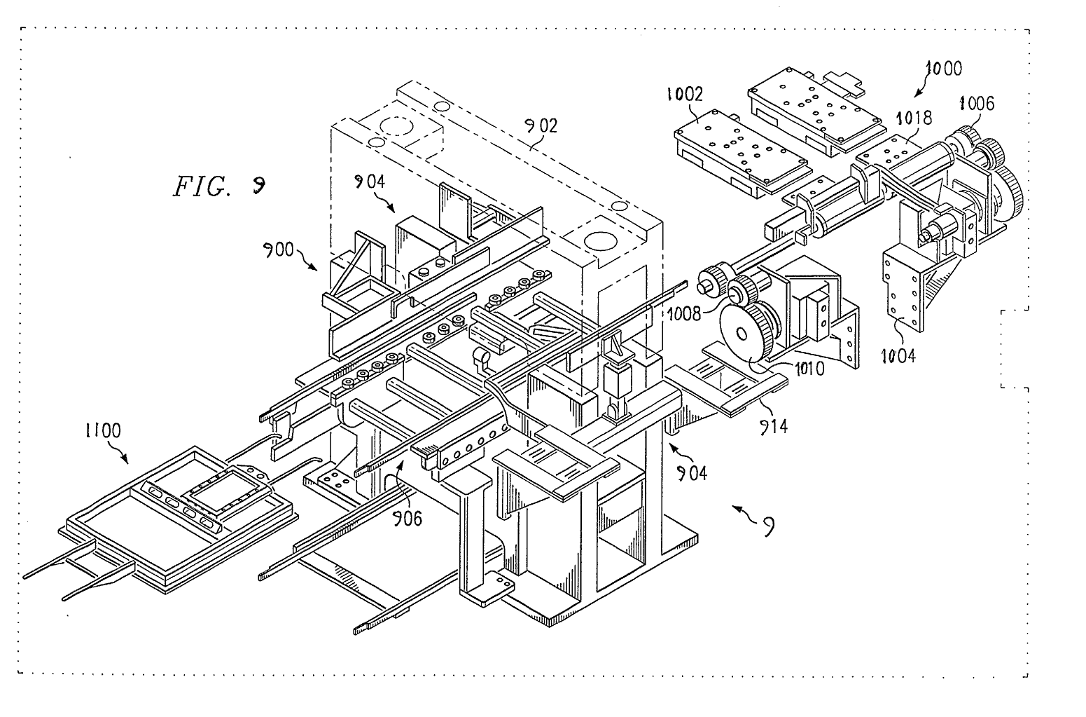

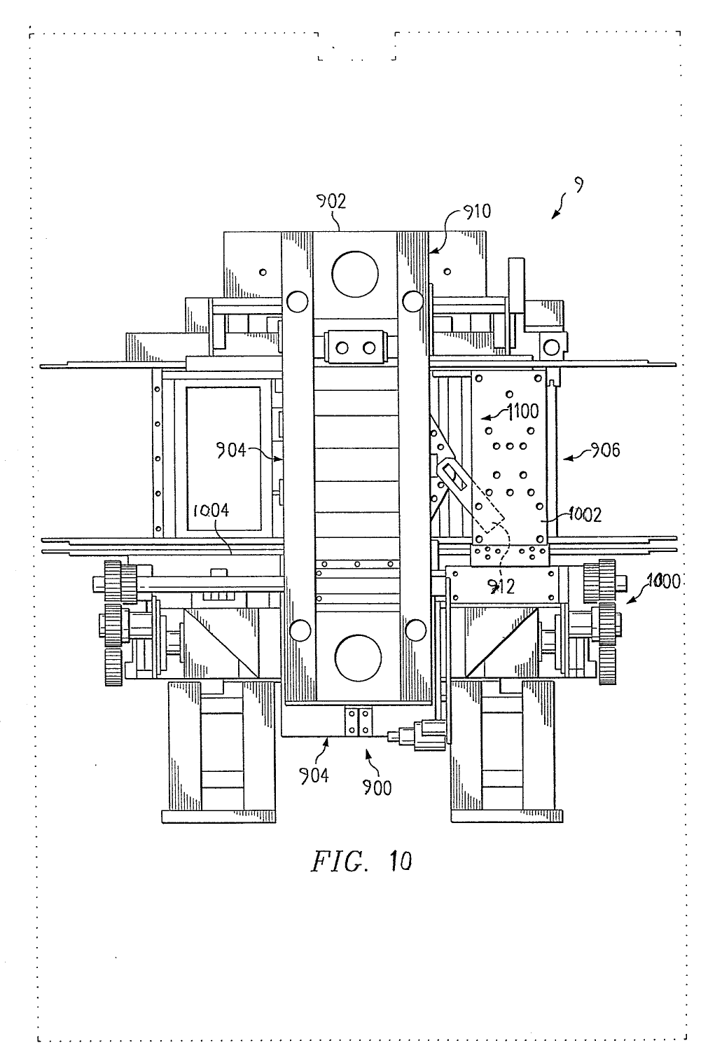

The emboss module 204 includes a frame 900, a die changer sub-assembly 1000, and a bolster sub-assembly 1100. FIG. 9 illustrates a perspective view of the emboss module 204 without the die changer 1000 and bolster sub-assemblies 1100 integrated therein for ease of understanding and explanation while FIGS. 10 and 11 illustrate top and side views, respectively, of the emboss module of FIG. 9 with the die changer 1000 and bolster sub-assemblies 1100 integrated therein. In FIG. 9, the top portion 902 of the frame 900 is removed for clarity and ease of understanding. The frame 900 receives both the die changer sub-assembly 1000 and the bolster sub-assembly 1100 to form the integrated emboss module 204 The die changer sub-assembly 1000 is used to automatically change die or dies, and the bolster sub-assembly 1100 is used to automatically change counters and panels during the embossing process. The dies and counters or panels are changed with minimal participation from an operator and without performing “make-ready” operations. The frame 900 further includes a dies changer registration system 904 for registering the die changer sub-assembly 1000 into the frame 900. The frame 900 also includes a scotch yoke 906, gripper bards, and a bolster-receiving arm 912 for receiving the bolster sub-assembly 1100 therein, which components are described in greater detail below.

The emboss module 204 a hydraulic power press 1010 and is capable of automatically registering the die changer sub-assembly 1000 therein. Commands for setting up, controlling, calibrating, positioning the emboss module 204, and the various components and sub-assemblies are performed via a computing system, as known in the art. Hardware and software are implemented within the computing system to control the emboss system and process control feedback. In addition, digital information for production matting of the die, tonnage, and proper sheet material design can be performed using bar code technology, again as known in the art. During operation, the emboss module 204, compresses a sheet of paper between the die and the counter or panel (described later herein). The compression creates tactile change of paper for texture, raised lettering, styled framing panel, and other embossment features, as known in the art.

During operation, the die is positioned on the die changer 1002 that is typically preheated. The die changer 1002 includes pre-drilled holes mated with pins therein. The die includes beveled edges cut to allow toggle clamps to hold the die on the die changer 1002. The die changer 1002 is registered into the swing arm 1004 and rotated into position, the swing arm 1004 being shuttled into the frame 900 and the die changer 1002 is registered with the die changer registration system 1004. When the die changer 1002 is in the embossing position, another die changer 1002 is simultaneously rotated out of the frame 900 for the next die to be placed therein. The die can be an emboss of foil die. The bolster sub-assembly 1100 shuttles, for example, a single panel flexible counter into position for the ingle panel emboss dies and shuttles an alternate triple panel flexible counter into position for double panel and triple panel emboss dies. The bolster sub-assembly 1100 is shuttled from the underside of the emboss module 204 from, for example, large to small format, or form flexible counter emboss to foil stamping.

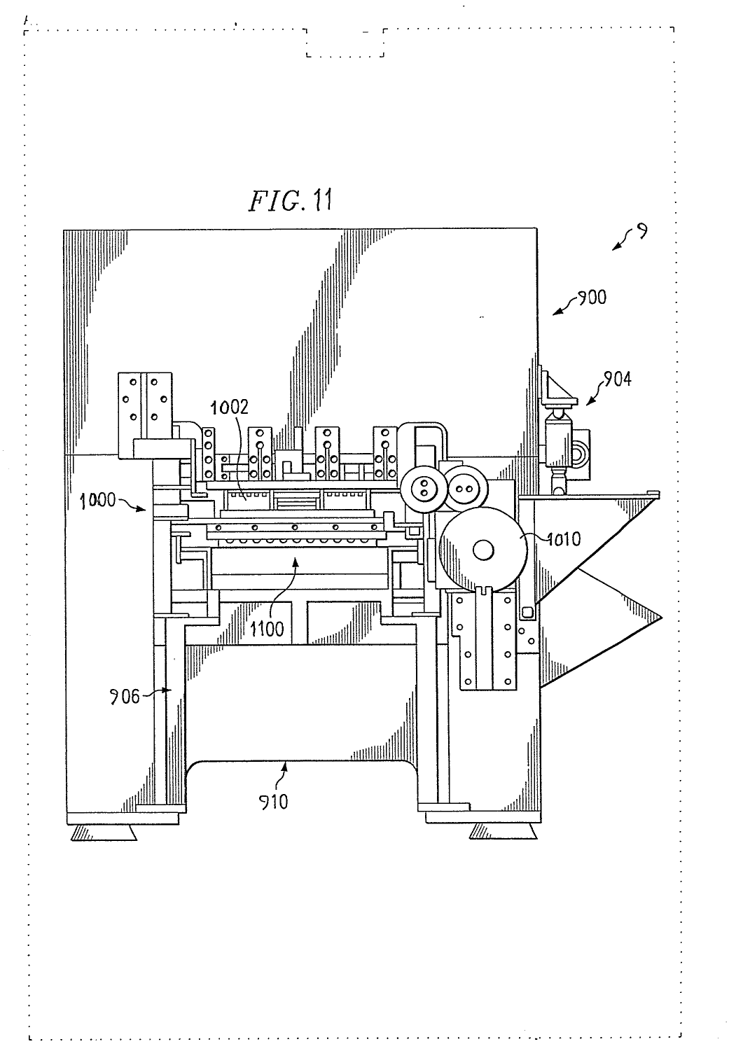

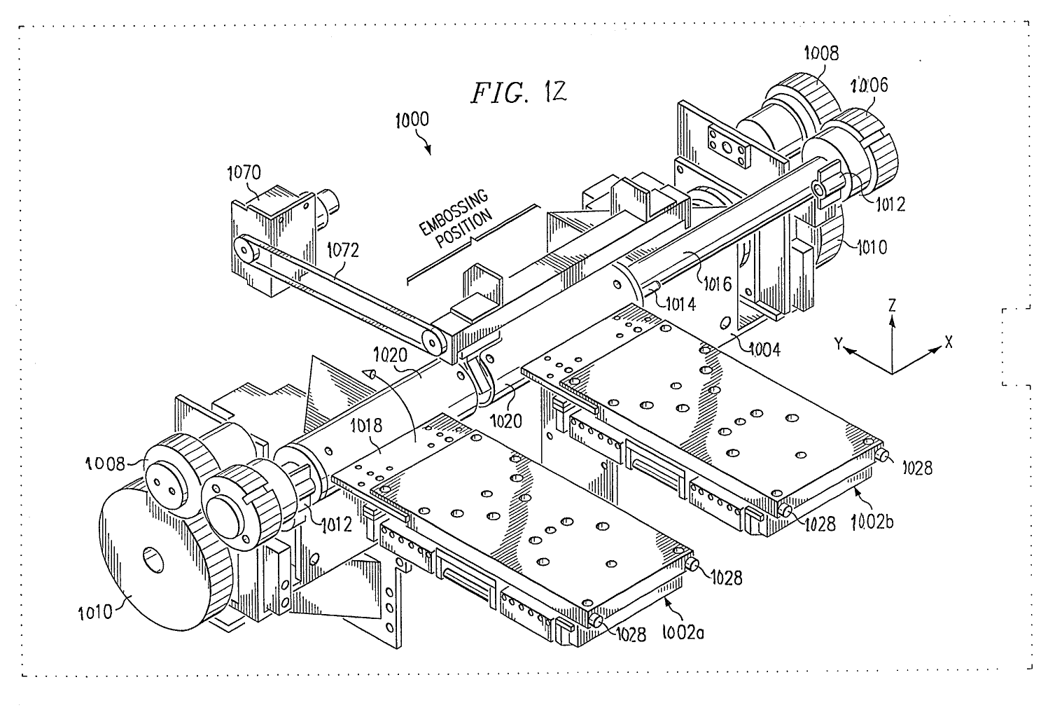

FIG. 12 illustrates a detailed perspective view of the die changer sub-assembly in accordance with the present invention. The die changers 1002 (1002a and 1002b) are illustrated facing down and registered in the die changer receiving ports 1018. The die changers 1002 are registered into the die changer receiving ports 1018 using a registered catch methodology. The die changers 1002 also include cam followers 1028 for registering into the frame 900. The face down position allows for the sheet of material to be embossed with a die. In greater detail, the changer sub-assembly 1000 includes several pair of gears 1006, 1008, 1010 and a shaft 1016 connecting the pair of gears 1006 to each other. The die changer receiving ports 1018 are connected to the shaft 1016 via cylindrical rollers 1020. The cylindrical rollers 1020 allow the die changers 1002 to rotate in both clockwise and counter-clockwise directions about the X-axis. In addition, the rollers 1020 are capable of moving along the X-axis through the shaft 1016. This is important function since this allows each die changer 1002 to be rotated about the X-axis. For instance, as currently illustrated in FIG. 12, the bottom-left die changer 1002a can be rotated, for example 180 degrees, in the counter-clockwise direction so that a different die can be placed therein. When rotated, the die changer 1002a would be facing up, and the existing die would be replaced with a different die. Concurrently, the other die changer 1002b can be used to emboss the sheet of material. Thereafter, when the different die is placed on the die changer 1002a and such die is needed for embossing, the die changer 1002a is rotated back 180 degrees to the position shown in FIG. 12. Then both the die changers 1002a, 1002b are shifted in the X-axis direction towards the upper right portion of the shaft 1016 such that the die changer 1002a is positioned to emboss the sheet of material. The die changer 1002b con now be rotated, for example 180 degrees, in the counter-clockwise direction about the X-axis so that a different die can be placed therein. The die changer resting plates 914 are used to hold the die changers 1002 when dies are being replaced. In this manner, automatic changing of the die can be performed with minimal interruption and no “make-ready” operations during the embossing process. The die changers 1002a, 1002b are shifted along the X-axis direction using an actuator 1070 having a belt 1072 and pulley system therein. When the die changers 1002a, 1002b are shifted along the X-axis direction of the shaft 1016 using the rollers 1020, the following mechanism can be used to lock or register them into place. For example, the rollers 1020 include tangs 1014 that lock into the tang ports 1012. Once engaged or locked, the swing arm 1004 can rotate one of the die changers about the X-axis. Again, the rollers 1020 can be rotated or shifted in the manner described above using a hydraulic unit, servo driver or other driving mechanism. These driving mechanisms should provide the necessary torque and power to rotate the die-changers 1002, which can weigh over 100 pounds, in both clockwise and counter-clockwise directions and in the X-axis direction.

Score Laser

After exiting the emboss station, the gripper transports the partially manufactured social expression product to the score laser which applies a score line to the partially manufactured social expression product at the location where the social expression product is to be folded.

Perfecting System

The gripper bar 610 as noted above, includes a portion that is rotatable so the partially manufactured social expression product can be flipped over to process the partially manufactured social expression product on the reverse side. For example, the size of the social expression product and the type of fold may require that the cut in the partially manufactured social expression product stock be made from the reverse side to minimize the residual effects of the cut on the front side of the social expression product so the cut is not noticeable to the customer.

FIG. 13 is a diagram illustrating an apparatus that mechanically perfects media using the rotating arrangement of perfector 1330 to rotate gripper bar 610. In this figure, a series of partially manufactured social expression products 1300A-1300C is shown as the successive gripper bars and their associated partially manufactured social expression products pass through the perfecter 1330. The gripper bar 610 maintains its hold on the partially manufactured social expression product 1300B, and thus the partially manufactured social expression product 1300B is mechanically perfected without requiring ungripping and regripping. The gripper bar 610 moves linearly through an assembly line conveyor, while the rotatable part 606 is designed to hold the partially manufactured social expression product 1300B being processed. In the transport system 202, gripper bar 610 is carried between a pair of chains 620A-B through a longitudinal slot in a plate 1350. The perfector 1330 adapted to flip the rotatable part 606 of the gripper bar 610 so that both sides of the partially manufactured social expression product may be processed. As part of the transport system 202 the chains 620A-B and the gripper bar 610 pass through the longitudinal slot or opening 1355 in the plate 1350. The plate 1350 rotatably carries a ring 1340 which is connected to an arrangement that engages the rotatable part 606 the gripper bar 610. A belt 1360 drives the ring 1340 and rotatable arrangement to rotate, thereby flipping the rotatable part 606 of the gripper bar 610. The ring 1340 is rotatably carried by the plate 1350. The ring 1340 is connected to the rotating arrangement 1330 that engages the rotatable part 606 of the gripper bar 610 when a motor (not shown) engages the drive gear 1365. In turn, the drive gear 1365 moves the belt 1360, which moves the ring 1340. The movement of the ring 1340 rotates the perfector 1330, which rotates the rotatable part 606, and thus perfects the partially manufactured social expression product. Gears 1370A-G guide the belt so that it engages the ring 1340. Drive gear 1365 may be attached to any driving mechanism, such as a motor, as is known in the art.

Cut Laser

After the perfecting system, the partially manufactured social expression product enters the cut laser which makes one or more cuts in the partially manufactured social expression product to separate the final social expression product(s) from the sheet of social expression product stock. The continuous suction to the wire cutting bed while the partially manufactured social expression product is indexed to the delivery position allows complete cutting of the social expression product perimeter with no attachment nicks. The rotation of the drum automatically engages the suction on the cutting beds at the proper moment, maintains the suction as the free-cut social expression product is indexed, and releases the suction when in the scrap release position. This operation is passive with no moving parts. The cutting bed is self-cleaning in that paper fragments typically remain in the vacuum chute of the wire cutting beds and fail to be carried away by the air suction. The inverted orientation of each wire cutting bed as it indexes to the bottom drum position tends to clear the bed of these fragments. The hex drum concept is extended by combining the hex drum with a gripper chain. The hex drum not only serves as the laser cutting bed, but also functions as the main drive sprocket for the gripper chain. The gripper bars of the gripper chain transition from the linear area of the gripper chain on to the hex drum. This provides a linear indexing region that is needed for the step and repeat platen processes such as emboss, provides the clearance needed to flip the grippers for perfecting, and provides all of the advantages of the hex laser drum in one system.

Fold Station

Once the social expression product is cut, a robot mechanism removes the social expression product from the scrap resulting from the cut and places the social expression product into the folding station. The folding station uses movable platens and a robotic arm to adjust for social expression products of different sizes and for social expression products that require multiple folds.

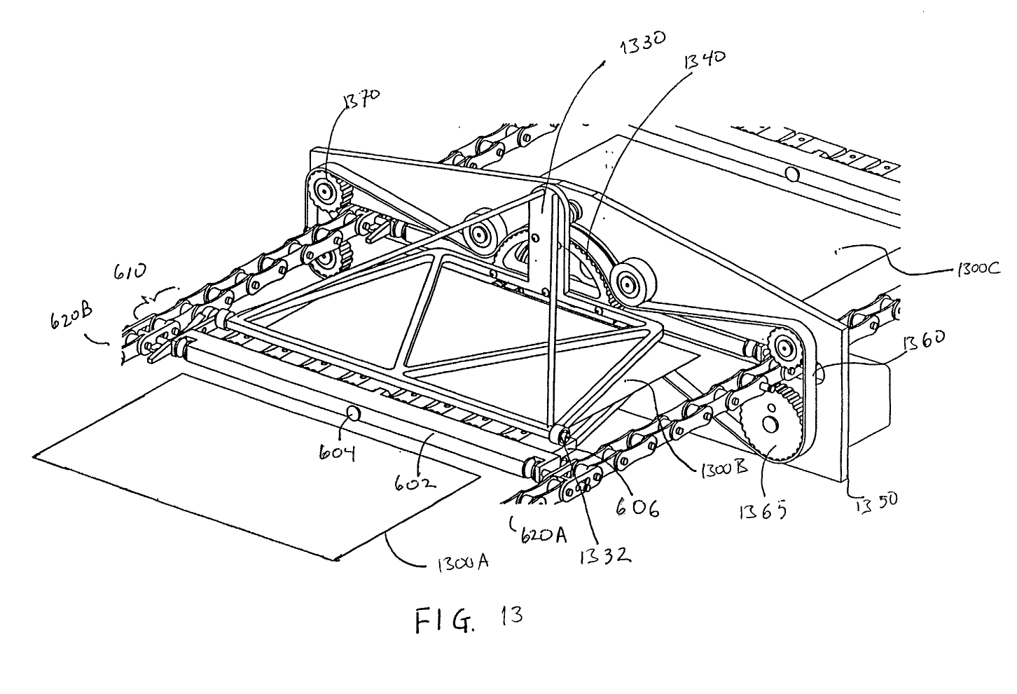

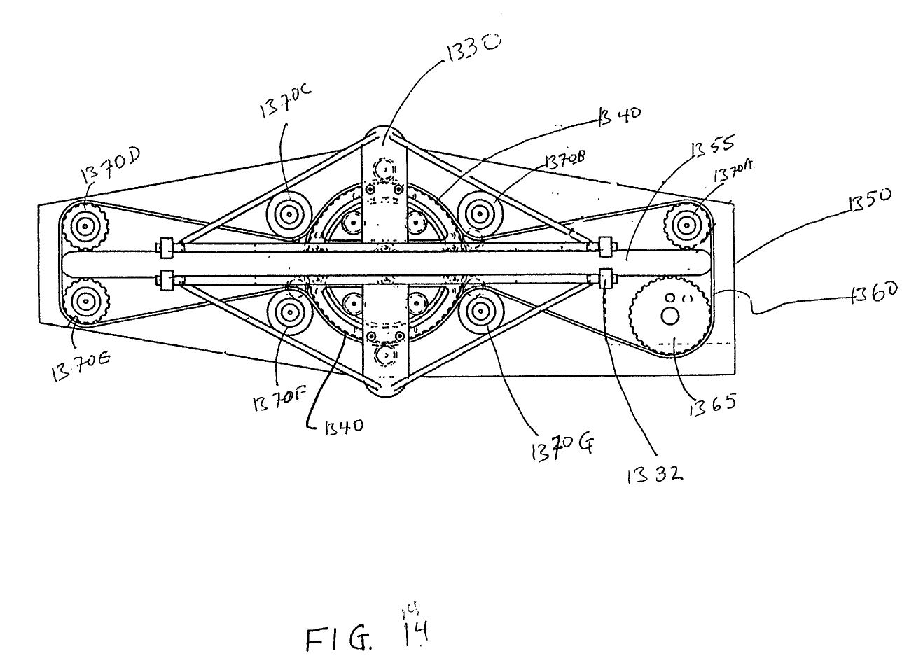

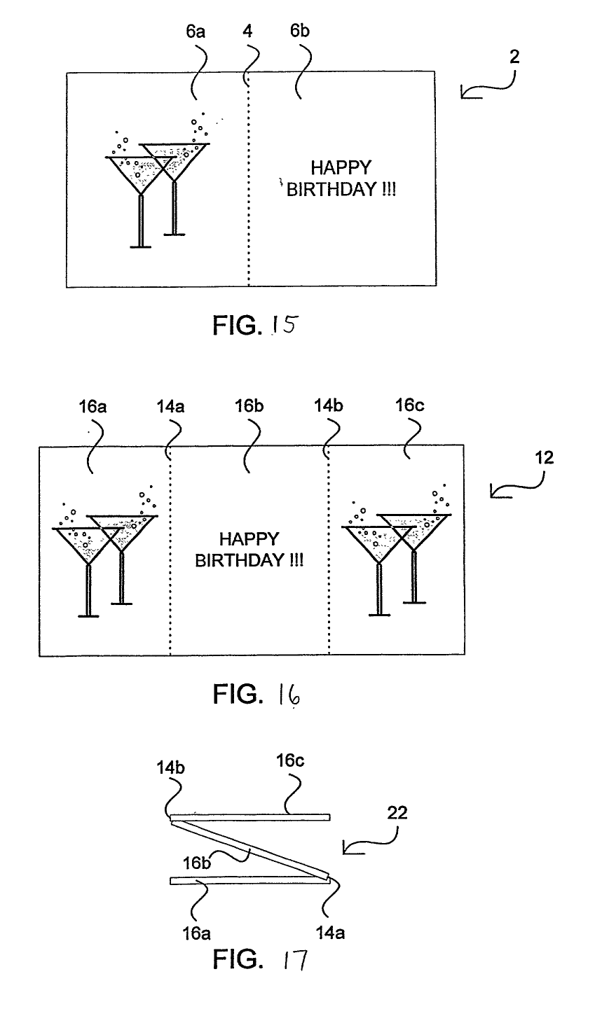

During the manufacturing process, cards can be folded in different styles. For example, FIGS. 15-17 illustrate various folds that are common in the industry. FIG. 15 illustrates an example of a regular fold of a card. As illustrated, a card 2 is evenly divided along a score line 4 to form two panels 6a, 6b. A regular fold occurs when the panel 6b is folded over the panel 6a (or vice versa) along the score line 4. The score line 4 can be creased or indented prior to folding one panel over the other. The regular fold is one of the most commonly used folds in the card industry. Next, FIG. 16 illustrates an example of a gate-fold of a card. As illustrated, a card 12 is evenly divided along a pair of score line 14a, 14b to form three panels 16a, 16b, 16c. A gate-fold occurs when the first outer panel 16c is first folded over the center panel 16b along the score line 14b. Thereafter, the second outer panel 16a is folded over panels 16b, 16c along the other score line 14a. Again, the score lines 14a, 14b can be creased or identified prior to folding the panels over each other. Alternatively, the card can be folded using a Z-fold method. A Z-fold occurs when the panels 16b, 16c are first folded over the panel 16a along the score line 14a. Thereafter, the panel 16c is back folded over panels 16b, 6a along the score line 4b to complete the Z-fold. FIG. 17 illustrates a side view of the Z-fold of the card 22.

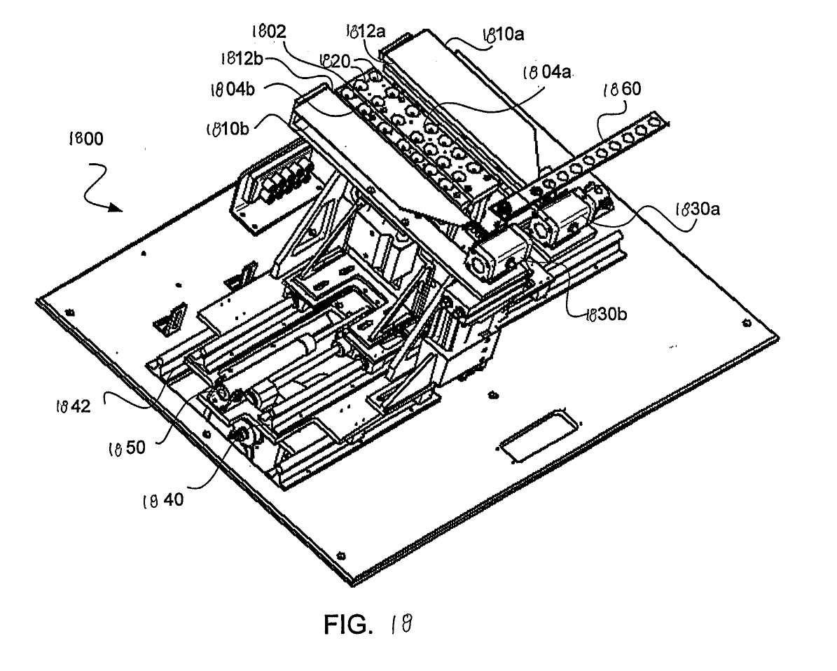

The manufacturing module for folding cards of different sizes, shapes, and styles has an adjustable vacuum bed and moveable gates. The vacuum bed is adjustable to accommodate cards of different widths. The vacuum bed includes multiple suction cups, which are individually connected to a vacuum supply. The vacuum supply independently controls each suction cup so that vacuum can be applied to all or selected suction cups to accommodate cards of different lengths. The movable gates are pivotally mounted with respect to the vacuum bed and operated by motors to pivot 180 degrees form open to closed positions to fold the cards. FIG. 18 illustrates a perspective view and FIG. 19 illustrates a top view of an adjustable folding station in accordance with the present invention. The folding station 1800 includes a vacuum bed 1802 and movable or folding gates 1810a, 1810b. One gate 1810a is preferably fixed in its position, whereas the other gate 1810b is adjustable in the y-direction using a servo drive (not shown) or other driving mechanism. The gates 1810a, 1810b as illustrated in FIGS. 18, 19 are shown in their open positions and can rotate around the x-axis about its ends 1812a, 1812b, respectively. When the gates 1810a, 1810b are fully rotated 180 degrees toward the vacuum bed 1802, the gates 1800a, 1810b are the their closed positions. The gates 1810a, 1810b are rotated or pivoted using motors such as a first gate actuator 1830a and a second gate actuator 1830b, respectively. Since gate actuators 1830a, 1830b are well known in the art, they are not described in great detail herein. In other embodiments, different devices that the gate actuators 1830a, 1830b can be used to rotate the gates 1810a, 1810b from their open to closed positions and vice versa. The gate actuators 1830a, 1830b are connected to gates 1810a, 1810b, respectively, via shafts, rods, and the like (not shown) and provide the necessary torque to rotate the gates 1810a, 1810b. In addition, a Z-fold gate 1860 may be used to assist in folding the card using the Z-fold process, which is described in greater detail later herein.

The vacuum bed 1802 includes two sections, a fixed bed section 1804a and an adjustable bed section 1804b. In other embodiments, the bed 1804a can be adjustable and the bed 1804b can be fixed. Both the fixed bed 1804a and the adjustable bed 1804b include multiple suction cups 1820 along the x and y directions of the beds 1804a, 1804b. The suction cups 1820 are individually connected to a vacuum supply (not shown). The vacuum supply is used to independently control each suction cup so that vacuum can be applied to selected or all suction cups 1820, depending on the length of the card. As is well known in the industry, the suction cups 1820 are used to secure the card within the vacuum bed 1802. The suction cups 1820 are generally made from any suitable material such as rubber, polymer, or other materials that are capable of securing the card on the vacuum bed 1802. Depending on the length of the card, vacuum is provided to selected suction cups 1820 for securing the card. For example, if the length of the card extends along the entire length (i.e., X-direction) of the vacuum bed 1802, then the vacuum supply can provide vacuum to all the suction cups 1820. Alternatively, if the length of the card is relatively short, then the vacuum supply can provide vacuum to selected suction cups 1820 that are covered by the card when the card is positioned on the vacuum bed 1802. In this manner, the folding station 1800 can accommodate cards with different lengths by way of supplying vacuum to selected or all suction cups 1820.

The folding station 1800 can also be used to accommodate cards with different widths using the adjustable gate 1810b and the adjustable vacuum bed 1804b. As illustrated, the adjustable gate 1810b and the adjustable vacuum bed 1804b are connected to each other and a pair of linear bearings 1804, 1842. In another embodiment, the adjustable gate 1810b and the adjustable vacuum bed 1804b may not be connected together and move about independently. A mechanism such as a ball screw 1850 can be used to drive the adjustable gate 1810b and the adjustable vacuum bed 1804b in the y-direction. In this manner, the vacuum bed 1802 can accommodate cards of different widths by adjusting the gate 1810b and the vacuum bed 1804b. As result, cards of different widths and lengths can be secured and folded using the folding station 1800. It should also be noted that the widths and the lengths of the cards vary depending on the card manufactures' specifications and possibly the customization options selected by the customer.

Although the present invention describes on ball screw 1850 and a pair of linear bearings 1840, 1842 to adjust the gate 1810b and bed 1804b in the y-direction, it is understood that any suitable number of ball screws and linear bearings, or a mechanism that does not rely on a ball screw and/or linear bearings are intended to be within the scope and spirit of the present invention. Also, although only two vacuum bed sections 1804a, 1804b and two gates 1810a, 1810b are illustrated herein, it is understood that in other embodiments more or less than two bed sections and gates can be used. In addition, other similar components/devices may be substituted for the ones described above.

Methods for folding the cards in different styles are described with reference to FIGS. 20-22. FIG. 20 illustrates a regular folding process of a card using the adjustable folding station. During operation, the vacuum bed 1804b and the gate 1810b are adjusted, depending on the width of the card, before placing the card thereon in step 2000. Thereafter, the card 2 (or multiple cards) is placed on the vacuum bed 1802 and the gate 1810 a (or gate 1810B) in step 2002. In other words, one panel 6a of the card 2 is placed on the vacuum bed 1802 and the other panel 6b is placed on the gate 1810a (or gate 1810b). The score line 4 on the card 2 is preferably positioned directly above the gate edge 1812a (or gate edge 112b). Next, the supply vacuum actuates the vacuum to all or selected suction cups 1820, depending on the length of the card, to secure the card therein step 2004. In step 2006, the gate 1810a (or gate 1810b) is pivoted or rotated 180 degrees from its open to closed position using the gate actuator 1830a (or gate actuator 1830b) to fold the card, resulting in the completion of the regular fold.

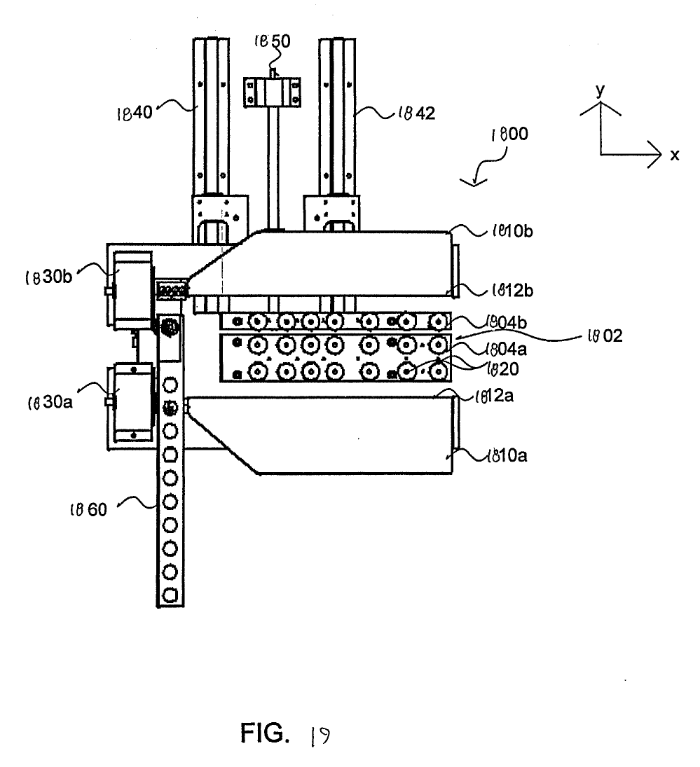

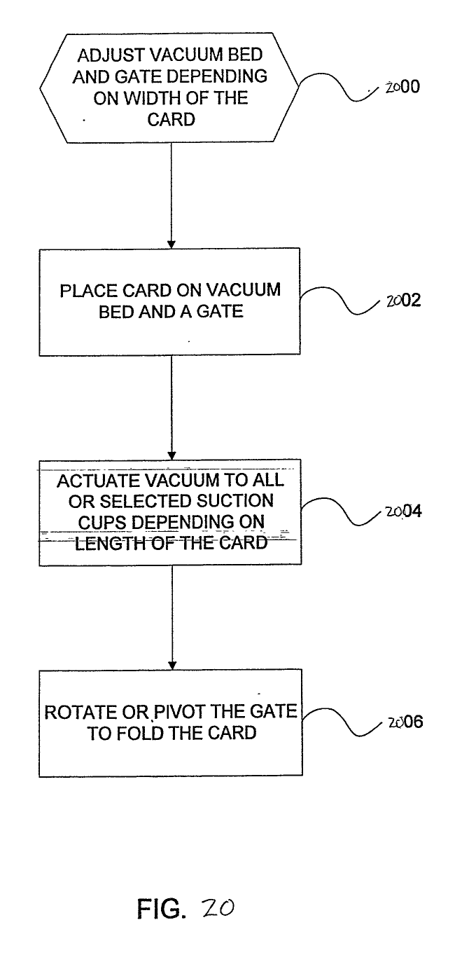

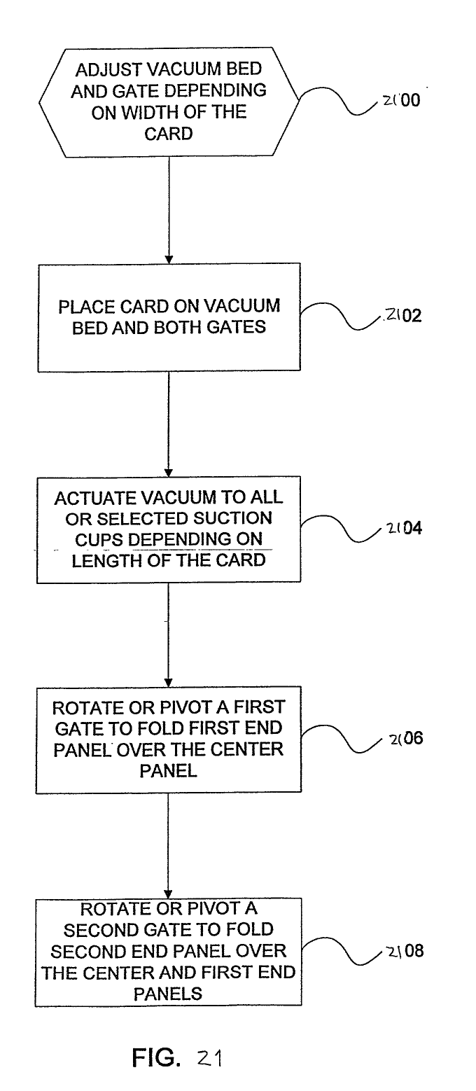

FIG. 21 illustrates a gate folding process of a card using the adjustable folding station. During operation, the vacuum bed 1804b and the gate 1810b are adjusted, depending on the length of the card, prior to placing the card thereon in step 2100. Thereafter, the card 12 (or multiple cards) is placed on the vacuum bed 102 and the gates 1810a, 1810b in step 2102. The center panel 16b is placed on the vacuum bed 1802 and the outer panels 16a, 16c are placed on the gates 1810a, 1810b, respectively. The score lines 14a, 14b are preferably positioned directly above the gate edges 1812a, 1812b, respectively. Next, the supply vacuum actuates the vacuum to all or selected suction cups 1820, depending on the length of the card, to secure the card therein in step 2104. In step 2106, the gate 1810a is pivoted or rotated 180 degrees using the gate actuator 1830a to fold the panel 16a over the panel 16b. Next, in step 2108, the gate 1810b is likewise pivoted or rotated 180 degrees using the gate actuator 1830b to fold the panel 16c over panels 16b, 16a, resulting in the completion of the gate fold.

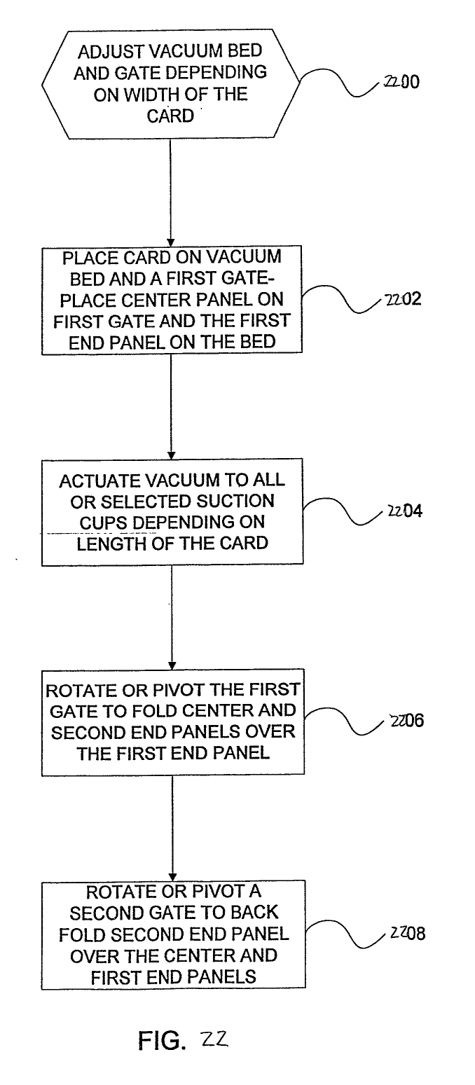

FIG. 22 illustrates a Z-folding process of a card using the adjustable folding station. During operation, the vacuum bed 1804b and the gate 1810b are adjusted, depending on the length of the card, before placing the card thereon in step 2200. Thereafter, the card 22 (or multiple cards) is placed on the vacuum bed 1802 and gate 1810a in step 2202. In other words, the center panel 16b is place on the gate 1810a and the first outer panel 16a is place on the vacuum bed 1802. The score line 14a is preferably positioned directly above the gate edge 1812a. Next, the supply vacuum actuates the vacuum to all or selected suction cups 1820, depending on the length of the card, to secure the card therein in step 2204. In step 2206, the gate 1810a is pivoted or rotated 180 degrees using the gate actuator 1830a to fold the center and second end panels 16b, 16c over the first end panel 16a. Next, in step 2208, the gate 1810b is likewise pivoted or rotated 180 degrees using the gate actuator 1830b to back fold the second end panel 16c over the first end and center panels 16a, 16b, resulting in the completion of the Z-fold. Alternatively, before back folding the second end panel 16c, the Z-fold gate 1860 can be rotated counter-clockwise about 90 degrees (i.e., perpendicular to its position shown in FIGS. 16-17) to secure the card 22. As shown, the Z-fold gate 1860 is positioned in a slightly higher plane than the gates 1810a, 1810b. In this manner, the Z-fold gate 1860 not only secures the card 22, but assists the gate 1810b in back folding the second end panel 16c over the first end and center panels 16a, 16b.

Accumulator Station

The accumulator 262 consists of two social expression product collection stations which receive social expression products from the fold set belt via a robotic mechanism 261, placing the first social expression product of a wholesale pack into the single accumulator station and the remaining social expression products of a wholesale pack into the multiple accumulator.

Assembly Nest

The assembly nest is the apparatus which collects the appropriate number of social expression products in a wholesale pack and their associated envelopes and a Pocket Identifier PID into a package. A first robot 265 picks the first social expression product of a wholesale pack from the single accumulator station into an assembly nest, then the associated PID and finally a second robot 263 retrieves the remaining social expression products of a wholesale pack from the multiple accumulator into the assembly nest. The assembly nest is then shuttled to the pack picker robot 267.

Overwrap

After a wholesale pack of social expression products has been created in an assembly nest, it is shuttled to overwrap sealers which wrap the wholesale pack of social expression products in an overwrap that adjusts to the size of the wholesale pack. The resultant package is moved past a printer which imprints stock management information in the package. Packaging module 2311 includes an article handler 2313, a plurality of film handlers 2315, and a side sealer 2317. A typical packaging module has an article handler 2313 that is an articulated arm, six-axis robot of the type well-known in the art. Film handlers 2315 are disposed within reach of material handler 2313. The construction and operation of each film handler 2315 is described in detail hereinafter. Each film handler 2315 is adapted to handle heat sealable plastic sheet material, which in the preferred embodiment is polyethylene film. The polyethylene film takes the form of a long strip folded in half along its long axis to form a long double strip having a closed side and an open side. The folded strip is wound into a roll, which is carried by a film handler 2315. Each film handler 2315 carries a roll of a different width material. Article handler 2313 is operated to select a film handler 2315 having a film width sufficient to accommodate the articles begin packaged, but without excess waste being created. Controller 2318 controls the operation of article handler 2313, film handlers 2315, and side sealer 2317. Controller 2318 is proved with information on the dimensions of the articles currently being packaged. Controller 2318 operates article handler 2313 to select the film handler 2315 appropriate for the width of the article, and to position and move the article appropriately with respect to film handler 2315. Controller 2318 operates film handler 2315 and side sealer 2317 to seal and cut the film.

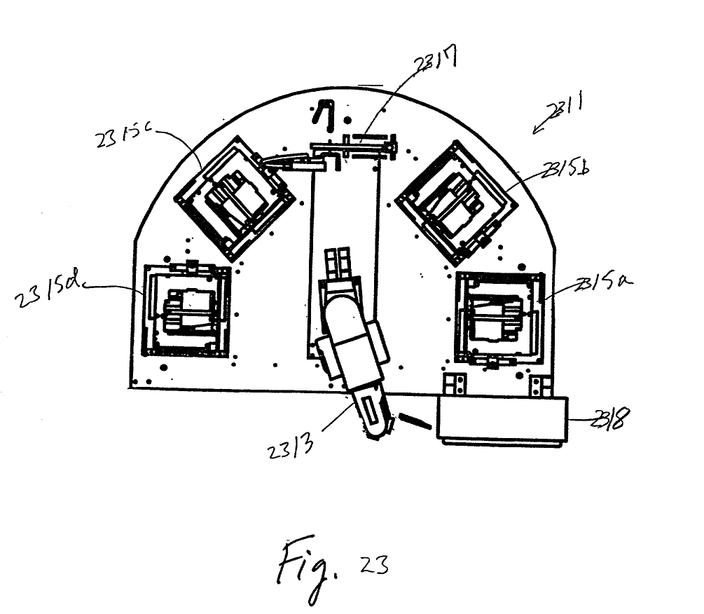

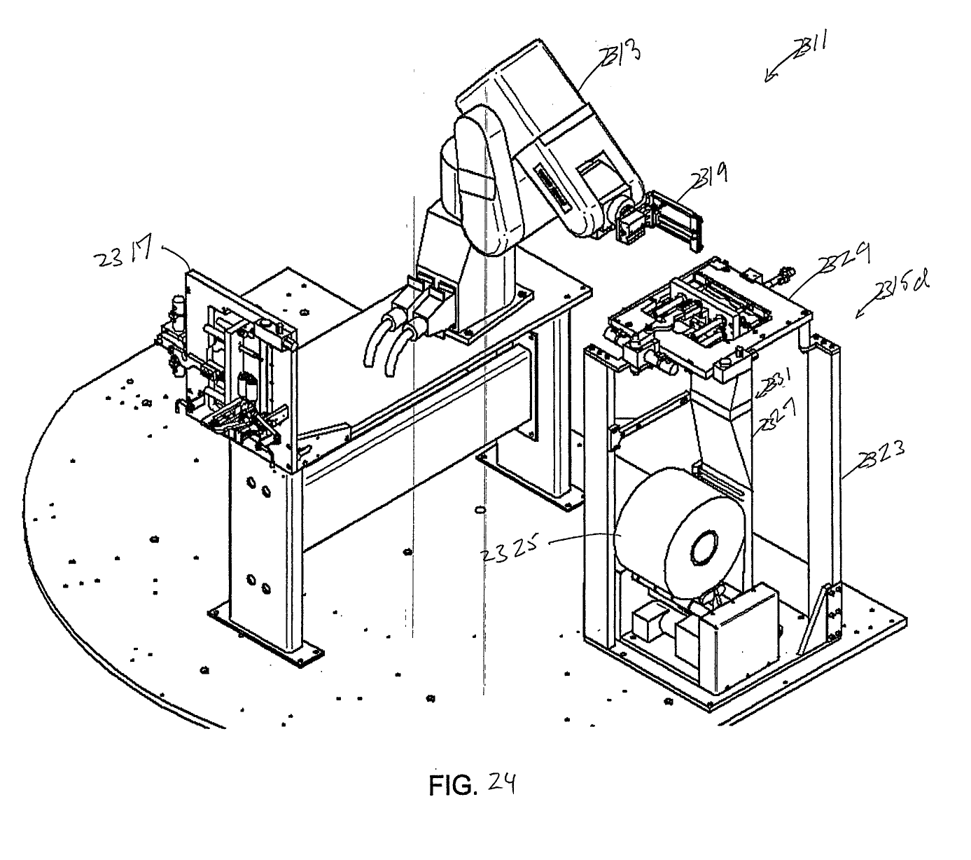

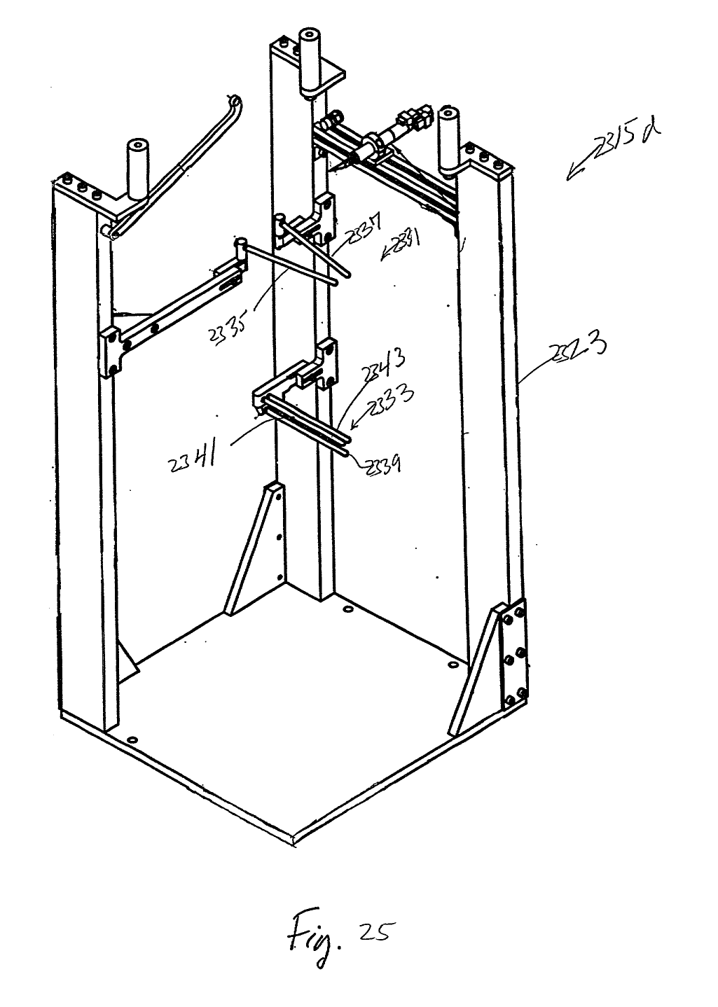

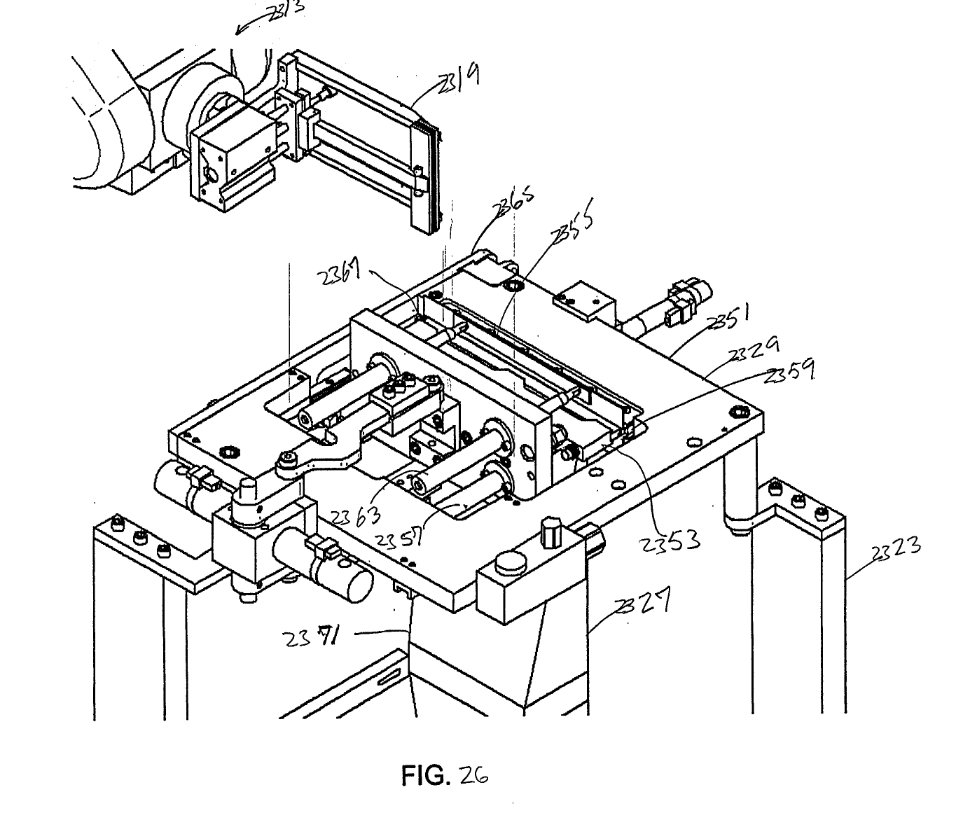

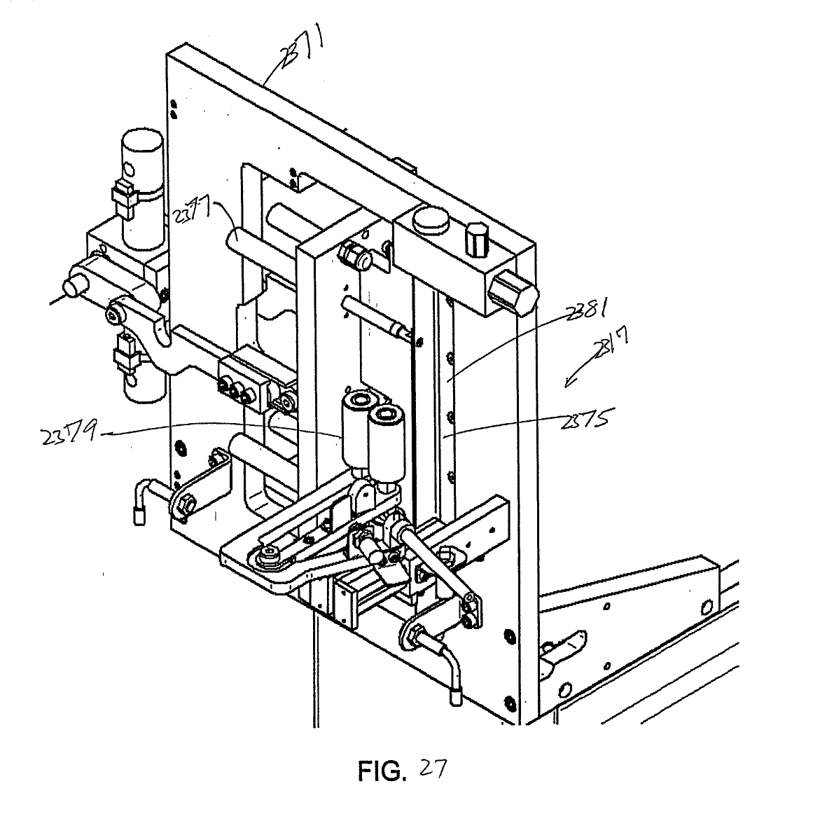

FIG. 24 shows further detail of material handler 2313, one film handler 2315d, and side sealer 2317. As shown in FIG. 24, article handler 2313 includes an article gripper 2319, which is adapted to grip the articles to be packaged, which in the preferred embodiment, are stacks of cards and envelopes. Film handler 2315 includes a frame 2323 that includes at least three legs. Frame 2323 supports a film roll 2325, which carries film 2327, folded according to the present invention. Film 2327 is trained between roll 2325 and a cross cutter 2329 through a film holding arrangement 2331. Film holding arrangement 2331 is adapted to hold open the open side of film 2327 so that articles may be inserted there into by article handler 2313. FIG. 25 shows details of film holder 2331. Film holder 2331 includes a film guide 2333 and a pair of relatively widely spaced apart fingers 2335 and 2337 positioned above film guide 2333. Film guide 2333 includes a first finger 2339 and a pair of closely spaced apart substantially parallel fingers 2341 and 2343 positioned closely above finger 2339. The film (not shown for purposes of clarity in FIG. 25) passes over finger 2339 and between fingers 2341 and 2343 and thence over fingers 2335 and 2337 toward cross cutter 2329 (shown in FIG. 26). Fingers 2335 and 2337 hold open the open side of the film so that articles may be inserted therebetween and within the film. FIG. 27 shows cross cutter 2329 that includes a plate 2351 mounted to frame 2323. Plate 2351 carries a heat sealing and cutting mechanism 2353 and film holding arrangement 2355. Heated blade arrangement 2353 is mounted parallel to plate 2351 and transverse to film 2327. Heated blade 2353 is moved in the pane of plate 2351 by actuators 2357 into and out of engagement with a platen 2359 to heat seal and cut film 2327. Film holder 2355 is also mounted parallel to plate 2351 and transverse to the movement of film 2327. Film holder 2355 is moved in the plane of plate 2351 by actuators 2363 into and out of engagement with film 2327. Cross cutter 2329 also includes a pivoting arm 65 mounted to plate 2351. Arm 2365 is adapted to pivot with respect to plate 2351 so as to form a lateral opening 2367 through which article holder 2329 may pass upwardly through plate 2351 during operation of the system of the present invention. When article holder 2319 is clear of plate 2351, arm 2351 is pivoted back to the position shown in FIG. 27 to impart rigidity to plate 2351 during actuation of heated blade 2353.

In operation, article holder 2319 holds the articles to be packaged, which in the preferred embodiment is a stack of greeting cards and envelopes, vertically below plate 2351 of cross cutter 2329. Article handler 2313 is actuated to inset article holder 2313, with the articles to be packaged, horizontally into the open side 2371 of film 2327. During the previous operation of cross cutter 2329, the upper end of film 2327 is sealed and held in place within cross cutter 2329 by film holder 2355. When article holder 2319 is fully inserted into film 2327 through open side 2371, actuators 2357 and 2363 are actuated to retract heated blade 2353 and film holder 2355. Then, article handler 2313 is actuated to move article holder 2319 vertically upward through the plane of plate 2351. The upper end of the articles engages the sealed end of film 2327. Further upward movement of article holder 2319 pulls film off roll 2325. When the lower end of the article to be packaged clear the plane of plate 2351, actuators 2357 and 2363 are actuated to close heated blade 2353 and film holder 2355. Heated blade 2353 seals and cuts film 2327 thereby to form a partial package around the articles. The partial package is sealed closely above and below the ends of the articles. FIG. 27 shows details of side sealer 2317. Side sealer 2317 is similar to cross cutter 2329 in that it includes a plate 2371 that carries a heated blade cutting and sealing instrument 2375. Heated blade 2375 is moved in the plane of plate 2371 by actuators 2377 into and out of engagement with a platen (not shown) to seal and cut the film. Side sealer 2317 includes a gripper arrangement mounted on the backside of plate 2371. Gripper 2379 is adapted to receive partially packaged articles from article holder 2319 of article handler 2313 through an opening 2381 in plate 2371 when heated blade 2375 is retracted. Gripper 2379 then moves the articles horizontally through the plane of plate 2371 until the edge of the article clears heated blade 2375. Then, actuators 2377 are actuated to close heated blade 2375, thereby to seal and cut the edge of the package.

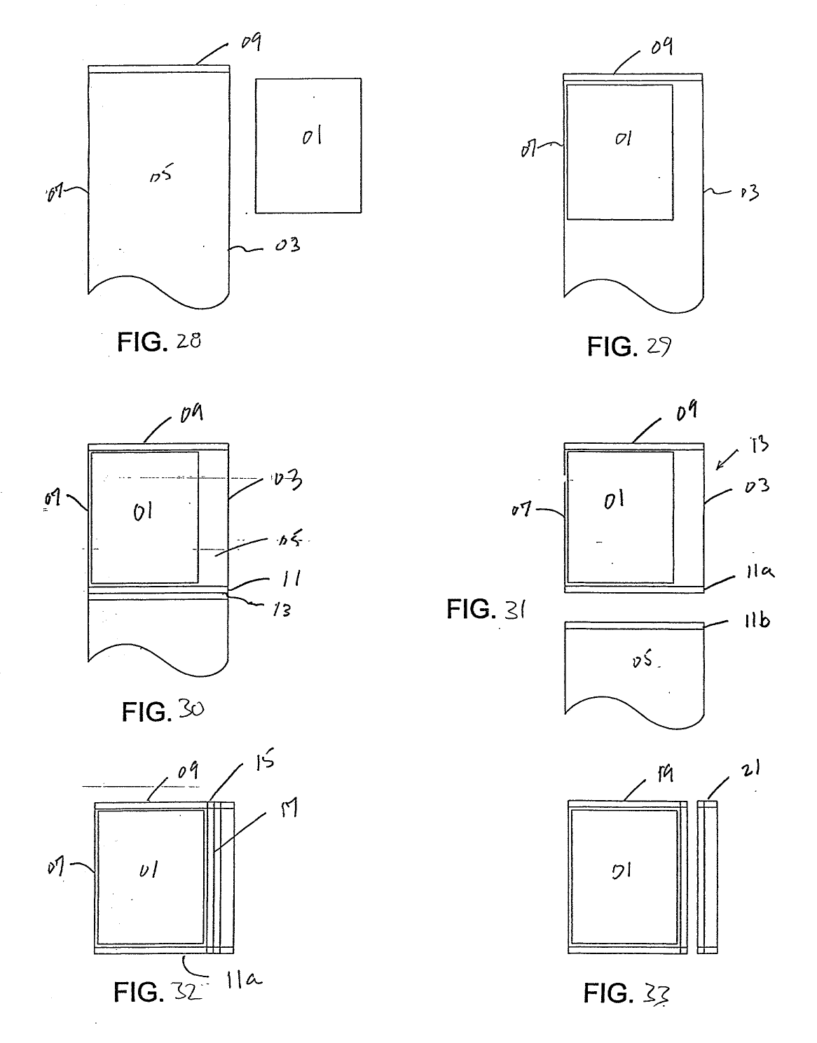

The method of sealing and packaging is illustrated with respect to FIGS. 28-33. In FIG. 28, a stack of cards 101 is positioned laterally adjacent to open side 103 of a strip of material 105. Material 105 is folded over so as to define a closed side 107. The upper end of strip 105 is sealed as indicated at 109. As shown in FIG. 29, the stack of articles is inserted sideways through open side 102 into a position closely adjacent closed side 107 and sealed edge 109. Then as shown in FIG. 30, film 105 is sealed, as indicated at 111, closely below the lower end of articles 101. Concurrently with sealing film 105 at 111, a cut 113 is made through seal 111, thereby allowing a partial package 113 to be separated form the remainder of film 105. As shown in FIG. 31, partial package 113 is sealed on its ends by seals 109 and 111A and at its left-most side by the closed end of the film. Partial package 113 is open along side 103. Then, referring to FIG. 32, a seal 115 is formed closely adjacent the right-most side of article 101. Concurrently with forming seal 115, a cut 1117 is made through seal 115. As shown in FIG. 33, a completed package 119 is formed by removing scrap 121.

Final Delivery System

The final delivery system places the overwrapped package on a conveyor belt where the package is transported to a boxing section which combines multiple wholesale packs into an order for a destination or packages the individual order into a mailer.

Summary

The on-demand fulfillment system enables customers to customize mass produced paper-based products, using sophisticated manufacturing processes, such as the application of foil, emboss, customized writing, customer photographs and the like, which processes are integrated on to high quality heavy print stock under tight quality control to produce different effects on the finished product. The automated assembly line draws production stock from a plurality of sources and routes the production stock through various customer selected manufacturing processes to produce a high quality, yet customized product at a reasonable cost to the customer.

What is claimed:

1. An on-demand fulfillment system for the customized production of products, the production of which comprises a multi-step manufacturing process, the on-demand fulfillment system comprising:
a plurality of manufacturing means, each adapted to automatically implement a step in a multi-step manufacturing process;
means for receiving product order data from a customer to define a product;
means, responsive to said received product order data, for automatically defining a multi-step manufacturing process to produce said defined product; and
means for automatically activating, in a sequence defined by said multi-step manufacturing process, ones of said plurality of manufacturing means to implement said defined multi-step manufacturing process.

2. The on-demand fulfillment system of claim 1 further comprising:
means connected to and interconnecting at least two of said manufacturing means for transporting a partially completed defined product from a first of said at least two of said manufacturing means to a second of said at least two of said manufacturing means.

3. The on-demand fulfillment system of claim 1 further comprising:
means for interconnecting said plurality of manufacturing means to transport, in a predetermined order, a partially completed defined product to each of said interconnected plurality of manufacturing means.

4. The on-demand fulfillment system of claim 3 wherein said means for defining comprises:
means, responsive to said received product order data, for identifying a plurality of said manufacturing means required to produce said defined product;
means for defining an operation to be performed by each of said identified plurality of said manufacturing means; and
means for generating a set of data that defines both said identified plurality of manufacturing means and an operation to be performed by each of said identified plurality of manufacturing means.

5. The on-demand fulfillment system of claim 4 wherein said means for activating comprises:
means, responsive to said generated set of data, for enabling each of said identified plurality of manufacturing means in sequence to perform said identified operation on a partially completed product as said partially completed product is transported by said means for transporting to each of said plurality of manufacturing means in said predetermined order.

6. The on-demand fulfillment system of claim 3 wherein said plurality of social expression product manufacturing means comprises:
means for feeding at least one piece of raw material to said means for transporting.

7. The on-demand fulfillment system of claim 6 wherein said plurality of social expression product manufacturing means further comprises:
means for registering said at least one piece of raw material on said means for transporting to enable successive ones of said plurality of manufacturing means to operate on said at least one piece of raw material located in a precise orientation on said means for transporting.

8. The on-demand fulfillment system of claim 7 wherein said plurality of social expression product manufacturing means further comprises at least two of: a printer, an emboss apparatus, a scoring apparatus, stock cutting apparatus, stock folding apparatus.

9. The on-demand fulfillment system of claim 3 wherein said plurality of manufacturing means comprises:
stack means for receiving and aggregating a predetermined plurality of manufactured social expression products.

10. The on-demand fulfillment system of claim 9 wherein said plurality of manufacturing means comprises:
packaging means for wrapping said predetermined plurality of manufactured social expression products into an integral package for delivery to a customer.

11. The on-demand fulfillment system of claim 1 wherein said means for receiving product order data comprises:
means for interfacing with a communication medium consisting of a one of the class of communication media including: IP network, Public Switched Telephone Network, cellular network.

12. The on-demand fulfillment system of claim 11 wherein said means for receiving product order data further comprises:
means for providing said customer with a plurality of data entry options to enable said customer to select and customize said product.

13. The on-demand fulfillment system of claim 11 wherein said means for receiving product order data further comprises:
means for receiving a pre-processed data file from a computer system that defines, at least in part, a multi-step manufacturing process to produce said defined product

14. The on-demand fulfillment system of claim 1 wherein said means for automatically defining comprises:
means, responsive to said received product order data, for generating a plurality of data files to control the operation of ones of said plurality of manufacturing means to implement said defined multi-step manufacturing process.

15. The on-demand fulfillment system of claim 14 wherein said means for automatically activating comprises:
means, responsive to said plurality of data files, for activating selected ones of said plurality of manufacturing means with a corresponding one of said plurality of data files to implement said defined multi-step manufacturing process.

16. An on-demand fulfillment system for the customized production of social expression products, the production of which comprises a multi-step manufacturing process, the on-demand fulfillment system comprising:
a plurality of social expression product manufacturing means, each adapted to automatically implement a step in a multi-step social expression product manufacturing process;
data interface means for receiving social expression product order data from a customer to define a social expression product;
process setup means, responsive to said received social expression product order data, for automatically defining a multi-step social expression product manufacturing process to produce said defined social expression product; and
process management means for automatically activating, in a sequence defined by said multi-step social expression product manufacturing process, ones of said plurality of social expression product manufacturing means to implement said defined multi-step social expression product manufacturing process.

17. The on-demand fulfillment system of claim 16 wherein said process setup means comprises:
social expression product component definition means, responsive to said received social expression product order data, for identifying a plurality of said social expression product manufacturing means required to produce said defined social expression product;
process step means for defining an operation to be performed by each of said identified plurality of said social expression product manufacturing means; and
control data generating means for generating a set of manufacturing apparatus control data that defines said identified plurality of social expression product manufacturing means, an operation to be performed by each of said identified plurality of social expression product manufacturing means, and a sequence of said operations to manufacture said social expression product.

18. The on-demand fulfillment system of claim 17 further comprising:
transport means for interconnecting said plurality of manufacturing means to transport, in a predetermined order, a partially completed defined product to each of said interconnected plurality of social expression product manufacturing means.

19. The on-demand fulfillment system of claim 18 wherein said plurality of social expression product manufacturing means comprises:
stock feed means for feeding at least one piece of printable stock to said transport means.

20. The on-demand fulfillment system of claim 19 wherein said plurality of social expression product manufacturing means further comprises:
stock registration means for registering said at least one piece of printable stock on said transport means to enable successive ones of said plurality of social expression product manufacturing means to operate on said at least one piece of printable stock located in a precise orientation on said transport means.

21. The on-demand fulfillment system of claim 20 wherein said process management means comprises:
means, responsive to said generated set of manufacturing apparatus control data, for enabling each of said identified plurality of social expression product manufacturing means in sequence to perform said identified operation on a partially completed social expression product as said partially completed social expression product is transported by said transport means to each of said plurality of social expression product manufacturing means in said predetermined order.

22. The on-demand fulfillment system of claim 21 wherein said plurality of social expression product manufacturing means further comprises at least two of:
printer means for printing customer selected content on said precisely oriented printable stock;
emboss means for embossing said precisely oriented printable stock;
printable stock scoring means for scoring said precisely oriented printable stock; and
fold means for folding said scored precisely oriented printable stock.

23. The on-demand fulfillment system of claim 22 wherein said plurality of social expression product manufacturing means comprises:
stack means for accumulating a plurality of said social expression product into a configuration for packaging.

24. The on-demand fulfillment system of claim 23 wherein said plurality of social expression product manufacturing means comprises:
packaging means for wrapping said stacked plurality of said social expression product for shipment to said customer.

25. The on-demand fulfillment system of claim 16 wherein said data interface means comprises:
communication network interface means for interconnecting with a communication medium consisting of a one of the class of communication media including: IP network, Public Switched Telephone Network, cellular network.

26. The on-demand fulfillment system of claim 25 wherein said data interface means further comprises:
screen display means for providing said customer with a plurality of data entry options to enable said customer to select and customize said product.

27. The on-demand fulfillment system of claim 25 wherein said data interface means further comprises:
file upload means for receiving a pre-processed data file from a computer system that defines, at least in part, a multi-step manufacturing process to produce said defined product

28. The on-demand fulfillment system of claim 16 wherein said process setup means comprises:
process file generation means, responsive to said received product order data, for generating a plurality of data files to control the operation of ones of said plurality of manufacturing means to implement said defined multi-step manufacturing process.

29. The on-demand fulfillment system of claim 28 wherein said process management means comprises:
manufacturing module control means, responsive to said plurality of data files, for activating selected ones of said plurality of manufacturing means with a corresponding one of said plurality of data files to implement said defined multi-step manufacturing process.

30. A method of operating an on-demand fulfillment system for the customized production of products, the production of which comprises a multi-step manufacturing process, the on-demand fulfillment system comprising a plurality of manufacturing modules, each adapted to automatically implement a step in a multi-step manufacturing process, the method comprising:
receiving product order data from a customer to define a product;
automatically defining, in response to said received product order data, a multi-step manufacturing process to produce said defined product; and
automatically activating, in a sequence defined by said multi-step manufacturing process, ones of said plurality of manufacturing modules to implement said defined multi-step manufacturing process.

31. The method of operating an method of operating anon-demand fulfillment system of claim 30 further comprising:
transporting a partially completed defined product from a first of at least two of said manufacturing modules to a second of said at least two of said manufacturing modules.

32. The method of operating an on-demand fulfillment system of claim 30 further comprising:
interconnecting said plurality of manufacturing modules to transport, in a predetermined order, a partially completed defined product to each of said interconnected plurality of manufacturing modules.

33. The method of operating an on-demand fulfillment system of claim 32 wherein said step of defining comprises:
identifying, in response to said received product order data, a plurality of said manufacturing modules required to produce said defined product;
defining an operation to be performed by each of said identified plurality of said manufacturing modules; and
generating a set of data that defines both said identified plurality of manufacturing means and an operation to be performed by each of said identified plurality of manufacturing modules.

34. The method of operating an on-demand fulfillment system of claim 33 wherein said step of activating comprises:
enabling, in response to said generated set of data, each of said identified plurality of manufacturing modules in sequence to perform said identified operation on a partially completed product as said partially completed product is transported to each of said plurality of manufacturing modules in said predetermined order.

35. The method of operating an on-demand fulfillment system of claim 32 comprising:
feeding at least one piece of raw material to a manufacturing module.

36. The method of operating an on-demand fulfillment system of claim 35 further comprising:
registering said at least one piece of raw material to enable successive ones of said plurality of manufacturing modules to operate on said at least one piece of raw material located in a precise orientation.

37. The method of operating an on-demand fulfillment system of claim 36 further comprising at least two of: printing, embossing, scoring, stock cutting, stock folding.

38. The method of operating an on-demand fulfillment system of claim 32 comprising:
receiving and aggregating a predetermined plurality of manufactured social expression products.

39. The method of operating an on-demand fulfillment system of claim 38 comprising:
wrapping said predetermined plurality of manufactured social expression products into an integral package for delivery to a customer.

40. The method of operating an on-demand fulfillment system of claim 30 wherein said step of receiving product order data comprises:
interfacing with a communication medium consisting of a one of the class of communication media including: IP network, Public Switched Telephone Network, cellular network.

41. The method of operating an on-demand fulfillment system of claim 40 wherein said step of receiving product order data further comprises:
providing said customer with a plurality of data entry options to enable said customer to select and customize said product.

42. The method of operating an on-demand fulfillment system of claim 40 wherein said step of receiving product order data further comprises:
receiving a pre-processed data file from a computer system that defines, at least in part, a multi-step manufacturing process to produce said defined product

43. The method of operating an on-demand fulfillment system of claim 30 wherein said step of automatically defining comprises:
generating, in response to said received product order data, a plurality of data files to control the operation of ones of said plurality of manufacturing modules to implement said defined multi-step manufacturing process.

44. The method of operating an on-demand fulfillment system of claim 43 wherein said step of automatically activating comprises:
activating, in response to said plurality of data files, selected ones of said plurality of manufacturing modules with a corresponding one of said plurality of data files to implement said defined multi-step manufacturing process.
